(19) United States
(12) Patent Application Publication
(10) Pub. No.: US 2026/0014895 A1
(43) Pub. Date: Jan. 15, 2026

(54) AUTOMATIC BATTERY EXCHANGE SYSTEM AND METHOD

(71) Applicant: Symbotic LLC, Wilmington, MA (US)

(72) Inventors: Zoe Dingeman, Wilmington, MA (US); Matt Stevens, Wilmington, MA (US); John Berrigan, Andover, MA (US); Todd E. Kepple, Litchfield, NH (US)

(21) Appl. No.: 19/266,690

(22) Filed: Jul. 11, 2025

Related U.S. Application Data
(60) Provisional application No. 63/670,460, filed on Jul. 12, 2024.

(51) Int. Cl. B60L 53/80

(52) U.S. Cl. CPC B60L 53/80

(57) ABSTRACT

An automatic battery swapping station, for an automated guided vehicle robot, includes: a housing closure with a narrowed opening forming access from inside the housing closure to the battery of the automated guided vehicle bot outside the automatic battery swapping station; a robotic transfer mechanism having a drive section and an end effector configured to grip the battery so that the battery is moved by the robotic transfer mechanism; and a battery storage inside the housing closure, and where the robotic transfer mechanism is arranged to move between at least one of the battery storage locations and outside the automatic battery swapping station so as to swap the battery of the automated guided vehicle robot outside the automatic battery swapping station with a stored battery in the at least one of the battery storage locations through the narrowed opening.

### CROSS REFERENCE TO RELATED APPLICATIONS

This application is an international application that claims priority from and the benefit of U.S. Provisional Patent Application No. 63/670,460 filed on Jul. 12, 2024, the disclosure of which is incorporated by reference herein in its entirety.

### BACKGROUND

### 1. Field

The present disclosure generally relates to material handling systems, and more particularly, to transport and storage of items within the material handling system.

### 2. Brief Description of Related Developments

Autonomous devices, such as mobile autonomous robots, are utilized throughout logistic warehouses to move goods and/or containers. In order to operate, the mobile autonomous robots require a power source, typically a battery, for various actions such as moving, gripping, etc. With use over time, the power source becomes depleted and requires a recharge or swap in order for the system to continue to operate. Consequently, the batteries periodically need to be recharged on-board or manually replaced by a human operator with a fully charged battery. While the batteries are being charged onboard, the mobile autonomous robot is limited from performing its intended functions during the charging operation. Moreover, manual swapping requires additional human operators to swap the batteries and a designated area where the human can access the mobile autonomous robot.

### BRIEF DESCRIPTION OF THE DRAWINGS

The foregoing aspects and other features of the present disclosure are explained in the following description, taken in connection with the accompanying drawings, wherein:

FIG. 1 is a schematic illustration of an automated storage and retrieval system in accordance with the present disclosure;

FIGS. 2A and 2B are schematic illustrations of a goods bot of the automated storage and retrieval system of FIG. 1 in accordance with the present disclosure;

FIG. 3 is a schematic illustration of a battery of the goods bot of FIGS. 2A and 2B in accordance with the present disclosure;

FIG. 4 is a schematic illustration of a battery of the goods bot of FIGS. 2A and 2B in accordance with the present disclosure;

FIG. 5 is a schematic illustration of a portion of the goods bot of FIGS. 2A and 2B in accordance with the present disclosure;

FIG. 6 is a schematic illustration of a portion of the goods bot of FIGS. 2A and 2B in accordance with the present disclosure;

FIGS. 7A-7B are schematic perspective illustrations of automatic battery swapping stations of the automated storage and retrieval system of FIG. 1 in accordance with the present disclosure;

FIGS. 8A-8B are schematic illustrations of the automatic battery swapping station of FIGS. 7A-7B in accordance with the present disclosure;

FIGS. 9A-9D are schematic illustrations of the automatic battery swapping station of FIGS. 7A-7B in accordance with the present disclosure;

FIGS. 10A-10F are schematic illustrations of portions of the automatic battery swapping station of FIGS. 7A-7B in accordance with the present disclosure;

FIGS. 11A and 11B are schematic perspective illustrations of an alternative automatic battery swapping station of the automated storage and retrieval system of FIG. 1 in accordance with the present disclosure;

FIG. 12A a schematic illustration of an alternative battery of the goods bot of FIGS. 2A and 2B in accordance with the present disclosure;

FIG. 12B-12E are an exemplary schematic illustrations of portions of the alternative battery of FIG. 12A and portions of an alternative automatic battery swapping station of the automated storage and retrieval system of FIG. 1 in accordance with the present disclosure;

FIG. 13 is flow diagram of an exemplary method in accordance with the present disclosure; and

FIG. 14 is flow diagram of an exemplary method in accordance with the present disclosure.

### DETAILED DESCRIPTION

The following detailed description is meant to assist the understanding of one skilled in the art, and is not intended in any way to unduly limit claims connected or related to the present disclosure.

The following detailed description references various figures, where like reference numbers refer to like components and features across various figures, whether specific figures are referenced, or not.

The word “each” as used herein refers to a single object (i.e., the object) in the case of a single object or each object in the case of multiple objects. The words “a,” “an,” and “the” as used herein are inclusive of “at least one” and “one or more” so as not to limit the noun being referred to as being in its “singular” form.

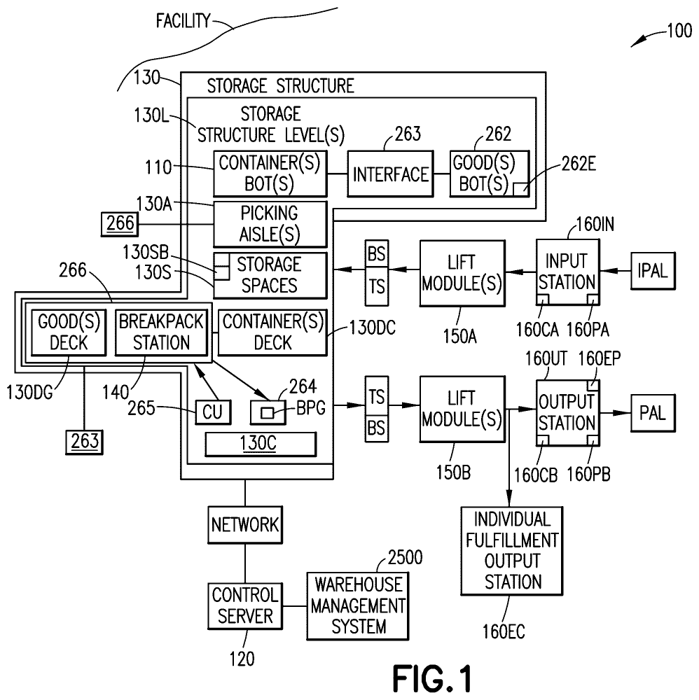

FIG. 1 is a schematic illustration of an automated storage and retrieval system (also referred to herein as a warehousing/warehouse system or product order fulfillment system) 100 in accordance with the present disclosure. Although the present disclosure will be described with reference to the drawings, it should be understood that the present disclosure can be embodied in many forms. In addition, any suitable size, shape or type of elements or materials could be used.

As used herein, the term “warehouse” may refer to any physical environment in which boxes or objects may be manipulated, processed, and/or stored by autonomously guided vehicle (AGV). In some examples, a warehouse may be a single physical building or structure, which may additionally contain certain fixed components, such as pallet racks for storing pallets of objects. Within examples, a heterogeneous warehouse robot fleet may be used for a number of different applications. One possible application includes order fulfillment (e.g., for individual customers), in which cases may be opened and individual items from the cases may be put into packaging within boxes to fulfill individual orders. Another possible application includes distribution (e.g., to stores or other warehouses), in which mixed pallets may be constructed containing groups of different types of products to ship to stores. Numerous other applications are also possible, including any space or environment populated with AGVs operating in the space or environment.

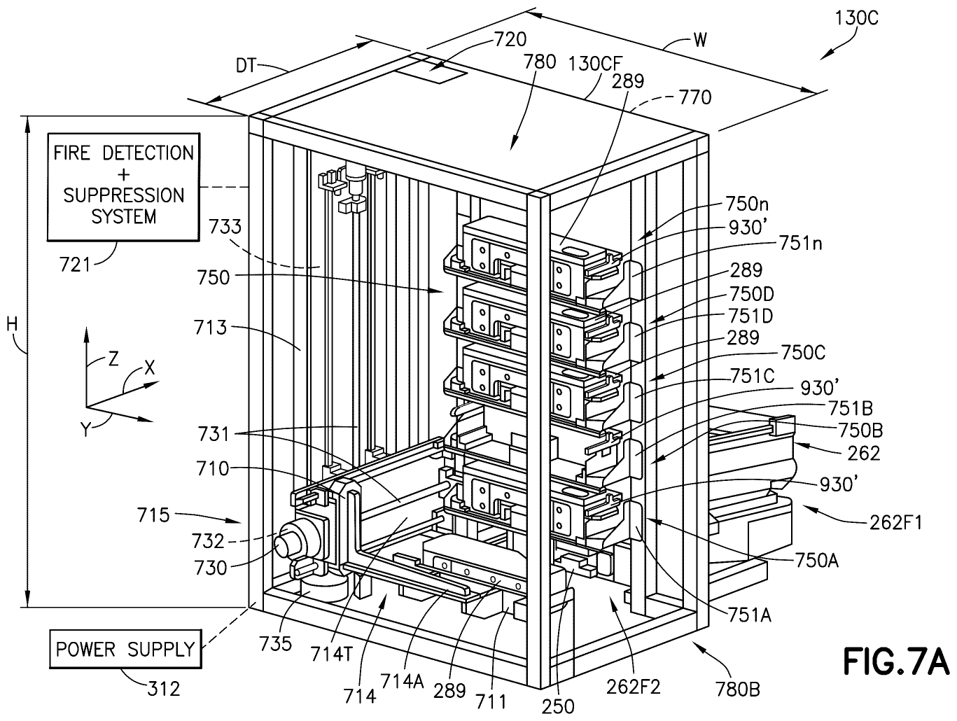

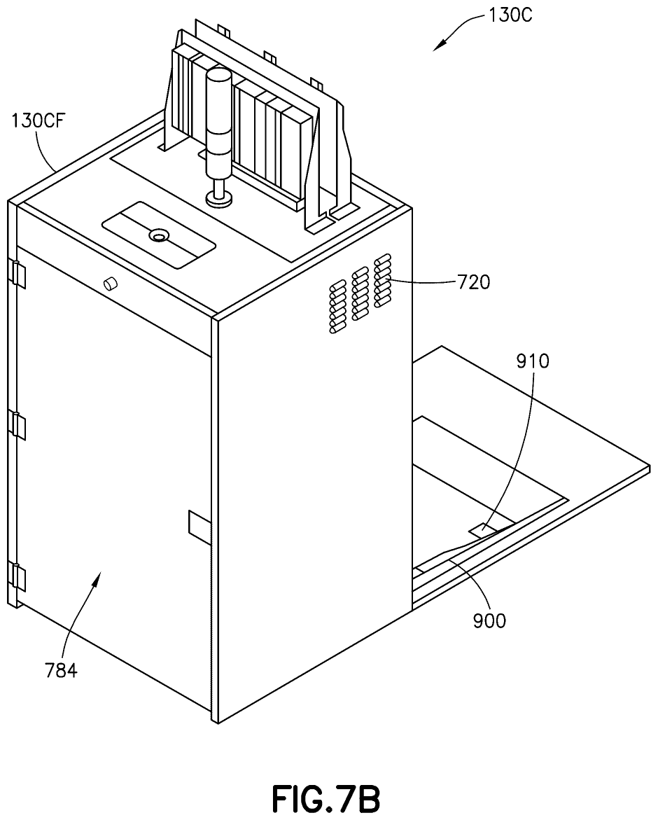

In accordance with the present disclosure, the automated storage and retrieval system 100 includes an automatic battery charging/swapping station 130C for automatically swapping/exchanging a discharged/depleted battery in an AGV. The automatic battery charging/swapping station 130C is utilized to store batteries and charge a depleted battery outside of and/or disconnected from a corresponding autonomously guided vehicle (AGV), which receives a new or recharged battery to continue operation within the automated storage and retrieval system 100. An advantage of the automatic battery swap is a reduction in the number of AGVs (e.g., goods robot 262, container robot 110, etc.) in the system 100. An automatic battery replacement results in it being unnecessary for AGVs to idle and charge at a charging station for an extended period of time, increasing throughput of the system with a smaller fleet of AGVs (i.e., a larger fleet of AGVs would be required in order to have the same system throughput as a system with swappable batteries, since idle charging AGVs cause significant downtime and thus, the need for extra AGVs to keep up with throughput). Additionally, automatic swapping of batteries results in a quicker recovery in the event of system shutdown, where batteries in idle AGV become drained over time (i.e., it is quicker to swap batteries rather than the need to recharge all AGVs after a system restart). The automatic battery charging/swapping station 130C includes a battery storage 750 with an array of battery storage locations 750A-n (FIG. 7A) to provide new or recharged batteries to mobile robots 110, 262 within a fleet of autonomously guided vehicles (AGV). Although the description will be described with respect to swapping of a battery from the goods robot 262, the methods and apparatus may also be applied to container robots 110 or any other mobile robot with the warehouse system 100. In particular, the automatic battery charging/swapping station 130C may replace a depleted battery with a recharged battery. The automatic battery charging/swapping station 130C results in a more efficient system where mobile robots 262 do not have to sit and wait for batteries to charge. It will be understood that the terms “charged” “recharged”, “fresh”, “drained”, “depleted”, “discharged”, etc. as used herein refer to whether a battery was most recently charged via the automatic battery charging/swapping station 130C or discharged via mobile robot operation, and is not intended to signify any particular charge state of a battery relative to a fully or partially recharged or discharged state. Moreover, battery charging/swap provides a protected, fire resistant space with a predetermined fire resistant criteria conforming to, at least, standards NFPA 1, 70, 855, UL 9540, and respective IFC, to ensure efficient battery charging and swap (criteria being one or more of, for example, a fire resistance rating of 2-hours, a specific material type, including detection systems, including suppression systems, specific dimensions, specific spacing, etc.). Battery swap times are thus efficient, though protected, with minimum AGV delays and downtime.

In accordance with the present disclosure, the automated storage and retrieval system 100 may operate in a retail distribution center or warehouse to, for example, fulfill orders received from retail stores for case units such as those described in U.S. Pat. No. 10,822,168 issued on Nov. 3, 2020, the disclosure of which is incorporated by reference herein in its entirety. For example, the case units are cases or units of goods not stored in trays, on totes or on pallets (e.g., uncontained). In other examples, the case units are cases or units of goods that are contained in any suitable manner such as in trays, on totes, in containers (such as containers of remainder goods after breakpack where the broken down case unit structure is unsuitable for transport of the remainder goods as a unit) or on pallets. In still other examples, the case units are a combination of uncontained and contained items. It is noted that the case units, for example, include cased units of goods (e.g., case of soup cans, boxes of cereal, etc.) or individual goods that are adapted to be taken off of or placed on a pallet. Shipping cases for case units (e.g., cartons, barrels, boxes, crates, jugs, or any other suitable device for holding case units) may have variable sizes and may be used to hold case units in shipping and may be configured so they are capable of being palletized for shipping. It is noted that when, for example, bundles or pallets of case units arrive at the storage and retrieval system the content of each pallet may be uniform (e.g., each pallet holds a predetermined number of the same item-one pallet holds soup and another pallet holds cereal) and as pallets leave the storage and retrieval system the pallets may contain any suitable number and combination of different case units (e.g., a mixed pallet where each mixed pallet holds different types of case units-a pallet holds a combination of soup and cereal) that are provided to, for example the palletizer in a sorted arrangement for forming the mixed pallet. The storage and retrieval system 100 described herein may be applied to any environment in which case units are stored and retrieved.

In accordance with the present disclosure, orders for filled items (e.g., the pallets, cases, containers, package of goods, individual (unpacked) goods, etc.) may be stochastic (e.g., substantially random in the items ordered and a time the order is received) and may be fulfilled by the automated storage and retrieval system 100 as function of time (e.g., sortation of ordered goods at a predetermined scheduled time in advance of a time the order is to ship/be fulfilled or in a sortation of goods in a just-in-time manner). These stochastic orders are determinative of a pick sequence of sorted items, such as for building a pallet load or pallet PAL (see, e.g., U.S. Pat. No. 8,965,559 titled “Pallet Building System” and issued on Feb. 24, 2015, the disclosure of which is incorporated herein by reference in its entirety). The pallet PAL may include mixed cases, mixed totes, mixed packs, mixed units (or caches) per tote, etc. The sorted items are picked from a common storage array (e.g., a storage array formed by storage spaces 130S of storage structure 130). The automated storage and retrieval system 100 effects a maximum throughput of goods for each order (e.g., received for processing by the automated storage and retrieval system 100) by employing or otherwise processing the order through one or more of the orthogonal sortation echelons (such as described in, for example, U.S. patent application Ser. No. 17/358,383 filed on Jun. 25, 2021 and titled “Warehousing System for Storing and Retrieving Goods in Containers,” the disclosure of which is incorporated herein by reference in its entirety) to a sortation level needed (e.g., e.g., the control server 120 drills/drives down through the orthogonal sortation echelons to effect the desired level of sortation needed for a given order—a case level sortation, a pack level sortation, a unit/each level sortation or a combination thereof) to effect a given order from the common storage array independent of order type (e.g., a pallet order, a case order, a pack order, mixed orders, etc.), independent of order sequence, and independent of order time. Accordingly, some AGVs may see higher battery depletion (more frequent tasks or longer duration tasks) than others. Efficient battery swap, on demand, results in minimum AGV downtime.

The automated storage and retrieval system 100 includes one or more breakpack modules 266. Exemplary breakpack modules 266 suitable for employment with the present disclosure include those described in U.S. provisional patent Nos. 63/452,749 filed on Mar. 17, 2023 and titled “Warehousing System for Storing and Retrieving Goods in Containers” with attorney docket number 1127P015998-US (-#1) and 63/452,758 filed Mar. 17, 2023 and titled “Warehousing System for Storing and Retrieving Goods in Containers” with attorney docket number 1127P016004-US (-#1), and those described in U.S. patents application Ser. Nos. 17/358,383 filed Jun. 25, 2021, 17/657,705 filed Apr. 1, 2022, and 18/323,758 filed May 25, 2023, the disclosures of which are incorporated herein by reference in their entireties. The breakpack module(s) 266 is/are configured to break down product containers or case units CU into breakpack goods containers 264 (also referred to herein as goods containers or totes for shipping goods) for order fulfillment. Product is placed into the breakpack goods containers 264 with automation (such as a goods bot or autonomous logistics mobile robot 262 as described herein) such that the products are loosely placed. As described herein, the mobile robot 262 (also referred to herein as an “autonomous logistics mobile robot” or “mobile robot”) 262 includes a payload bed 310 for holding goods unit(s) (also referred to herein as breakpack good(s)) BPG loaded on the mobile robot 262, where the payload bed 310 has or otherwise forms an end effector 262E arranged to selectively extend and unload the breakpack goods BPG from the payload bed 310.

The automated storage and retrieval system 100 may include (in addition to or in lieu of the breakpack modules 266) one or more each pick modules substantially similar to those described in U.S. Pat. No. 9,037,286 issued on May 19, 2015 (the disclosure of which is incorporated herein by reference), where the breakpack goods containers 264 are filled by human or robotic operators and output for transport by at least one autonomous container transport vehicle 110 (also referred to herein as “container bots” or “autonomous guided vehicles” and which form at least a part of an asynchronous transport system for level transport as described herein) for placement in storage or for transfer to an output station 160UT.

A control server 120 of the automated storage and retrieval system 100 is configured to effect operation of a container bot 110 and a mobile robot 262 for assembling orders of breakpack goods BPG from supply containers 265 (e.g., case units CU) into breakpack goods containers 264 and outfeed of breakpack goods containers 264 through container outfeed stations TS. For example, the control server 120 is configured to effect operation of the container bot(s) 110 between the container storage locations 130S, a breakpack operation station 140 (of a breakpack module 266), and a breakpack goods container 264 located along a breakpack goods transfer deck 130DG; the control server 120 is configured to effect operation of the bot(s) 262 so that transport of the breakpack goods BPG, by the mobile robot 262 traversing the goods transfer deck 130DG, sorts the breakpack goods BPG, e.g., in a unit/each level sortation, to corresponding breakpack goods containers 264; and/or the control server 120 is configured to effect operation of the container bot(s) 110 (e.g., traversing a container transfer deck 130DC) so that the container bot(s) 110 accesses corresponding breakpack goods containers 264 at the goods transfer deck 130DG and transports the breakpack goods containers 264 via traverse along the container transfer deck 130DC to at least one of a container output/transfer station TS and a corresponding container storage location 130SB of the storage spaces 130S of a corresponding level 130L of a multilevel storage array (i.e., storage structure 130).

It is noted that when, for example, incoming bundles or pallets (also referred to as pallet loads) IPAL (e.g., from manufacturers or suppliers of case units) arrive at the storage and retrieval system 100 for replenishment of the automated storage and retrieval system 100, the content of each pallet IPAL may be uniform (e.g., each pallet holds a predetermined number of the same item-one pallet holds soup and another pallet holds cereal). The cases of such pallet IPAL may be substantially similar or in other words, homogenous cases (e.g., similar dimensions), and may have the same SKU (otherwise, as noted before the pallets may be “rainbow” pallets having layers formed of homogeneous cases). As pallets PAL leave the storage and retrieval system 100, with cases filling customer replenishment orders, the pallets PAL may contain any suitable number and combination of different case units CU (e.g., each pallet may hold different types of case units-a pallet holds a combination of canned soup, cereal, beverage packs, cosmetics and household cleaners). The cases combined onto a single pallet may have different dimensions and/or different SKU's.

The storage and retrieval system 100 may be configured to generally include an in-feed section, a storage and sortation section (where storage of items is optional), and an output section. The storage and retrieval system 100 operating for example as a retail distribution center may serve to receive uniform pallet loads IPAL of cases, breakdown the pallet goods or disassociate the cases (e.g., at input station 160IN) from the uniform pallet loads into independent case units CU handled individually by the system 100, retrieve and sort the different cases CU sought by each order into corresponding groups, and transport and assemble the corresponding groups of cases (e.g., at the output station 160UT) into what may be referred to as mixed case pallet loads (see pallet load PAL noted above). The system 100 operating, for example, as a retail distribution center may serve to receive uniform pallet loads IPAL of cases, breakdown the pallet goods or disassociate the cases from the uniform pallet loads (e.g., at the input station 160IN) into independent case units CU handled individually by the system, retrieve and sort the different cases sought by each order into corresponding groups, and transport and sequence the corresponding groups of cases in the manner described in U.S. Pat. No. 9,856,083 issued on Jan. 2, 2018, the disclosure of which is incorporated herein by reference in its entirety.

The storage and sortation section includes a multilevel automated storage system that has an automated transport system that in turn receives or feeds individual cases CU into the multilevel storage array for storage in a storage area (such as storage spaces 130S of the storage structure 130). The storage and sortation section also defines outbound transport of case units from the multilevel storage array such that desired case units are individually retrieved in accordance with commands generated in accordance to orders entered into a warehouse management system, such as warehouse management system 2500, for transport to the output section. The storage and sortation section may receive individual cases, sort the individual cases (utilizing, for example, the buffer and interface stations), e.g., in a case level sortation, and transfer the individual cases to the output section in accordance to orders entered into the warehouse management system 2500. The sorting and grouping of cases according to order (e.g., an order out sequence) may be performed in whole or in part by either the storage and retrieval section or the output section, or both, the boundary between being one of convenience for the description and the sorting and grouping being capable of being performed any number of ways. The intended result is that the output section assembles the appropriate group of ordered cases, that may be different in SKU, dimensions, etc. into mixed case pallet loads in the manner described in, for example, U.S. Pat. No. 8,965,559 issued on Feb. 24, 2015 and titled “Pallet Building System,” the disclosure of which is incorporated herein by reference in its entirety.

In the present disclosure, the output section generates the pallet load in what may be referred to as a structured architecture of mixed case stacks. The structured architecture of the pallet load described herein is representative however; the pallet load may have any other suitable configuration. For example, the structured architecture may be any suitable predetermined configuration such as a truck bay load or other suitable container or load container envelope holding a structural load. The structured architecture of the pallet load may be characterized as having several flat case layers as described in U.S. Pat. No. 9,856,083, the disclosure of which is incorporated by reference herein in its entirety.

Still referring to FIG. 1, the automated storage and retrieval system 100 includes a storage array (e.g., storage structure 130 having storage spaces 130S) with at least one elevated storage level 130L (where more than one elevated storage levels forms storage racks of stacked storage levels). Mixed product units are input and distributed in the storage array in cases CU of product units of common kind per case CU (each case input to the system 100 holds a common kind of stock keeping unit (SKU)). For example, the automated storage and retrieval system 100 includes input stations 160IN (which include depalletizers 160PA and/or conveyors 160CA for transporting items (e.g., inbound supply containers) to lift modules (or lifts) 150A for entry into a storage level 130L of the storage structure 130).

The automated storage and retrieval system 100 includes an automated transport system (e.g., bots, breakpack stations, and other suitable level transports described herein) with at least one asynchronous transport system for transporting cases/products on a given storage structure level 130L (e.g., level transport). The storage and retrieval system 100 includes undeterministic container bots 110 that travel along one or more physical pathways of the storage and retrieval system (e.g., such as one or more of the picking aisles 130A and container transfer deck 130DC) to provide at least one level of asynchronicity. The container bots 110 may be any suitable independently operable autonomous transport vehicles that carry and transfer case units along X and Y throughput axes throughout the storage and retrieval system 100. The container bots 110 may be automated, independent (e.g., free riding) autonomous transport vehicles. Suitable examples of container bots can be found in, for exemplary purposes only, U.S. Pat. No. 10,822,168 issued on Nov. 3, 2020; U.S. Pat. No. 8,425,173 issued on Apr. 23, 2013; U.S. Pat. No. 9,561,905 issued on Feb. 7, 2017; U.S. Pat. No. 8,965,619 issued on Feb. 24, 2015; U.S. Pat. No. 8,696,010 issued on Apr. 15, 2014; U.S. Pat. No. 9,187,244 issued on Nov. 17, 2015; U.S. Pat. No. 11,078,017 issued on Aug. 3, 2021; U.S. Pat. No. 9,499,338 issued on Nov. 22, 2016; U.S. Pat. No. 10,894,663 issued on Jan. 19, 2021; and U.S. Pat. No. 9,850,079 issued on Dec. 26, 2017, the disclosures of which are incorporated by reference herein in their entireties. The container bots 110 may be configured to place case units, such as the above described retail merchandise, into picking stock in the one or more levels of the storage structure 130 and then selectively retrieve ordered case units.

At least another level of asynchronicity is provided such that, for example, case/product holding locations are greater than the number of bots transporting cases/products. At least one lift module (or lift) 150B is provided for transporting cases/products between storage levels 130L (e.g., between level transport). The at least one lift 150B is communicably connected to the storage array (e.g., formed by the storage spaces 130S of the storage level(s) 130L) so as to automatically retrieve and output, from the storage array, product units distributed in the cases CU in a common part (e.g., the storage locations 130S of a respective storage level 130L) of the at least one elevated storage level 130L of the storage array. The output product units being one or more of mixed singulated product units, in mixed packed groups, and in mixed cases. As an example, the automated storage and retrieval system 100 includes output stations 160UT, 160EC (which include palletizers 160PB, operator stations 160EP and/or conveyors 160CB for transporting items (e.g., outbound supply containers and filled breakpack goods (order) containers) from lift modules 150B for removal from storage (e.g., to a palletizer (for palletizer load) or to a truck (for truck load)). The output station 160EC may be an individual fulfillment (or e-commerce) output station where, for example, filled breakpack goods (order) containers including single goods items and/or small bunches of goods are transported for fulfilling an individual fulfillment order (such as an order placed over the Internet by a consumer). The output station 160UT may be a commercial output station where large numbers of goods are generally provided on pallets for fulfilling orders from commercial entities (e.g., commercial stores, warehouse clubs, restaurants, etc.). The automated storage and retrieval system 100 may include both the commercial output station 160UT and the individual fulfillment output station 160EC, although the automated storage and retrieval system may include one or more of the commercial output station 160UT and the individual fulfillment output station 160EC.

The automated storage and retrieval system 100 also includes the input and output vertical lift modules 150A, 150B (generally referred to as lift modules 150-it is noted that while input and output lift modules are shown, a single lift module may be used to both input and remove case units from the storage structure), a storage structure 130 (which may have at least one elevated storage level as noted above and may form a multilevel storage array), and at least one container bot 110 which may be confined to a respective storage level of the storage structure 130 and are distinct from a transfer deck 130DC on which they travel. It is noted that the depalletizers 160PA may be configured to remove case units from pallets so that the input station 160IN can transport the items to the lift modules 150 for input into the storage structure 130. The palletizers 160PB may be configured to place items removed from the storage structure 130 on pallets PAL for shipping. As used herein the lift modules 150, storage structure 130 and container bots 110 may be collectively referred to herein as the multilevel automated storage system (e.g., storage and sorting section) noted above, which has an integral “on the fly sortation” (e.g., sortation of case units during transport of the case units) so that case unit sorting and throughput occurs substantially simultaneously without dedicated sorters as described in U.S. Pat. No. 9,856,083, previously incorporated herein by reference in its entirety.

The lifts 150 may be connected via transfer stations TS to the container transfer deck 130DC, and each lift is configured to lift one or both of supply containers 265 (empty or filled) and the breakpack goods containers 264 (empty or filled) into and out of the at least one elevated storage level 130L of the storage structure 130. Container storage locations (or spaces) 130S are arrayed peripherally along the container transfer deck 130DC and/or picking aisles 130A such as described in U.S. Pat. No. 9,856,083, previously incorporated by reference herein in its entirety and U.S. Pat. No. 10,822,168 issued on Nov. 3, 2020, the disclosure of which is incorporated herein by reference in its entirety.

The container transfer decks 130DC are substantially open and configured for the undeterministic (i.e., not physically constrained) traversal of container bots 110 along multiple travel lanes across and along the container transfer decks 130DC. As described in U.S. Pat. No. 10,556,743 issued on Feb. 11, 2020 and having application Ser. No. 15/671,591 (the disclosure of which is incorporated herein by reference in its entirety) the multiple travel lanes may be configured to provide multiple access paths or routes to each storage location 130S (e.g., pickface, case unit, container, or other items stored on the storage shelves) so that container bots 110 may reach each storage location using, for example, a secondary path if a primary path to the storage location is obstructed. The container transfer deck(s) 130DC at each storage level 130L communicate(s) with each of the picking aisles 130A on the respective storage level 130L.

One or more of the breakpack modules 266 may be disposed in a picking aisle(s) 130A or accessed from the container transport deck 130DC such as described in U.S. patent application Ser. Nos. 17/358,383 filed on Jun. 25, 2021 (titled “Warehousing System for Storing and Retrieving Goods in Containers”) and 17/657,705 filed on Apr. 1, 2022 (titled “Warehousing System for Storing and Retrieving Goods in Containers”), the disclosures of which were previously incorporated herein by reference in their entireties.

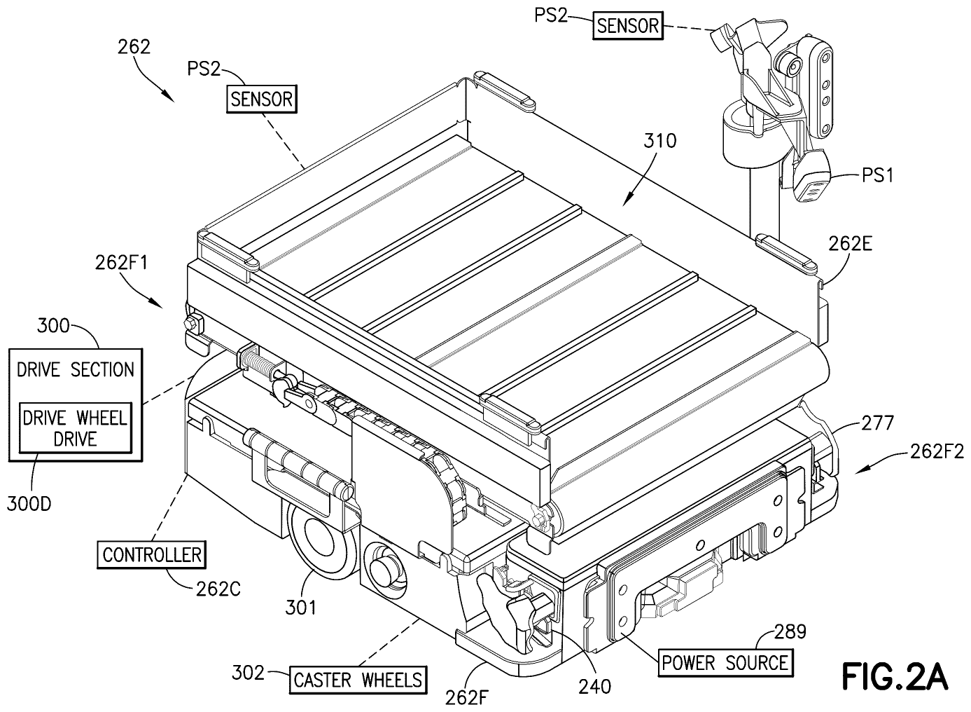

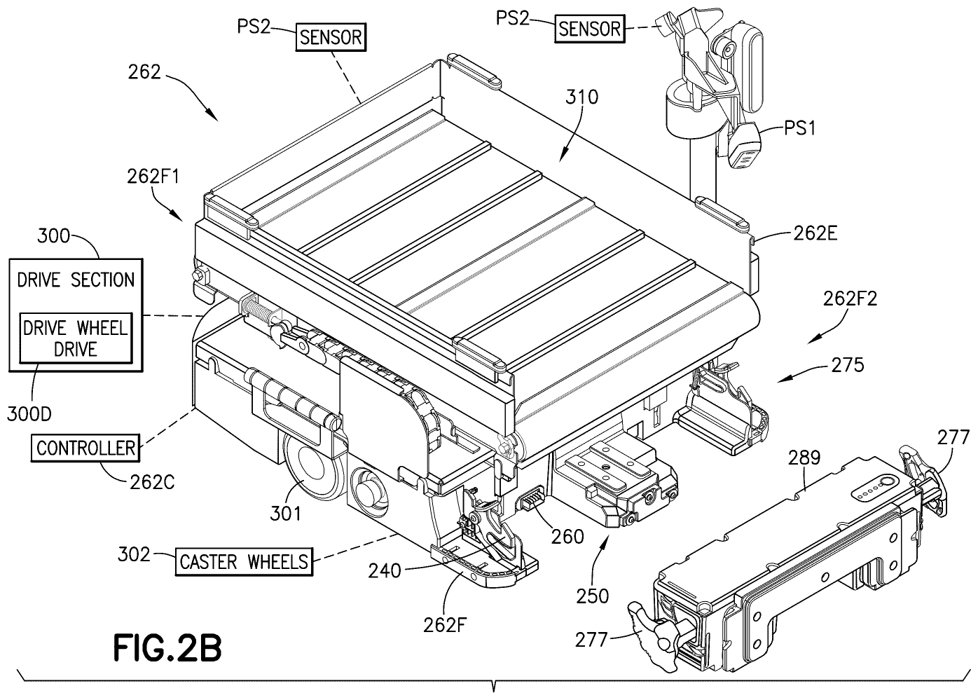

Referring now to FIGS. 1, 2A, and 2B, the at least one mobile robot 262 is arranged or otherwise configured for transporting, along the goods transfer deck 130DG, one or more breakpack goods BPG (also referred to herein as a goods payload unit, e.g., a packed goods payload unit that is unpacked from the supply container 265 in a pack level sort or a unpacked goods payload unit (i.e., unit/each) unpacked from a packed goods payload unit in a unit/each level sort) between the breakpack operation station 140 and the breakpack goods interface 263. The container bot(s) 110 is also configured to autonomously pick and place the breakpack goods containers 264 at the breakpack goods interface 263. The breakpack goods interface 263 may be substantially similar to one or more of the transfer stations TS and buffer stations BS and include an undeterministic surface upon which breakpack goods containers 264 are placed so as to form an undeterministic interface between the goods transfer deck 130DG and the container transfer deck 130DC.

The mobile robots 262 may be any suitable type of autonomously guided bot or autonomous logistics mobile robot with a payload configured for holding breakpack goods BPG (e.g., received from the breakpack operation station 140). The mobile robots 262 are configured so as to automatically unload one or more breakpack goods BPG (retrieved from the breakpack operation station 140) from the mobile robot 262 to breakpack goods containers 264 at the breakpack goods interface 263. Suitable examples of goods bots can be found in, for example, in U.S. Provisional Application No. 63/657,215 filed on Jun. 7, 2024; and U.S. Provisional Application No. 63/657,262 filed on Jun. 7, 2024, the disclosures of which are incorporated by reference herein in their entireties.

The mobile robot 262 is configured as a holonomic vehicle that is capable of holonomic movement and traverse. Accordingly, the mobile robot 262 may be non-holonomic, traveling along non-holonomic (non φ radius turns) paths. The mobile robot 262 includes a vehicle frame 262F, a drive system or section 300, and a payload bed or bay 310. The drive section 300 is operably connected to the vehicle frame 262F to autonomously move the mobile robot 262 within a facility (such as the retail distribution center or warehouse). The payload bed 310 is disposed on the vehicle frame 262F and is arranged to stably hold breakpack goods BPG thereon, where the breakpack goods BPG are transported with the mobile robot 262. The payload bed 310 is movably connected to the vehicle frame 262F so that the payload bed 310 moves between extended and retracted positions relative to the vehicle frame 262F.

The frame 262F is configured so that the mobile robot 262 traverses, as a unit, on at least one of a transfer deck (such as the goods deck 130DG). A controller 262C is connected to the frame 262F and is configured (via any suitable non-transitory computer readable code including, which may include but is not limited to neural networks) to effect movement of the mobile robot 262 on the at least one of the goods deck 130DG so that the mobile robot 262 roams freely via autonomous navigation, from a first location to a different second location, wherein the first location may be a supply of the goods unit (such as a breakpack station 140), and the second location may be a tote fill location (such as at interface 263) based on an order. For example, a pair of drive wheels 301 are coupled to the frame 262F at any suitable location(s). In the example illustrated in the Figures, the drive wheels 301 are disposed substantially mid-way between the longitudinal ends 262F1, 262F2 of the frame 262F for effecting at least holonomic motion of the mobile robot 262 along a surface on which the mobile robot 262 rides; although the drive wheels 301 may be adjacent one end 262F1 of the frame 262F as described in U.S. provisional patent application No. 63/452,735 filed on Mar. 17, 2023 and titled “Warehousing System for Storing and Retrieving Goods in Containers” with attorney docket number 1127P017025-US (-#1), the disclosure of which is incorporated herein by reference in its entirety. The drive wheels 301 are driven by a drive wheel drive 300D of the drive section 300. The drive wheel drive 300D is operated under control of any suitable controller 262C of the mobile robot 262 to effect transfer of breakpack goods BPG. The drive wheel drive 300D may be any suitable drive such as direct drive motors coupled to respective wheels 301 or any other suitable drive(s) employing any suitable transmission for imparting rotation to one or more of the wheels 301 (e.g., independent rotation of each wheel and/or differential rotation of the wheels).

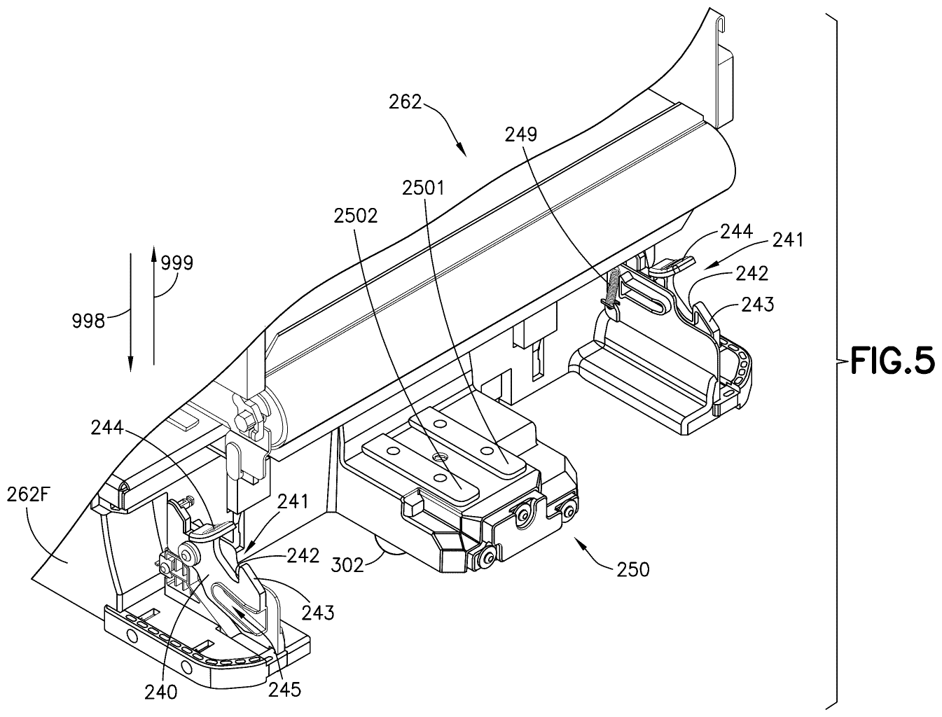

At least one caster wheel 302 (FIG. 5) may be coupled to the frame 262F adjacent at least one of the ends 262F1, 262F2 of the frame 262F2, although caster wheels 302 are described, the wheel(s) 302 may be steerable wheels. The drive wheels 301 and the at least one caster wheel 302 support the frame 262F for traverse of the mobile robot 262 on and along, e.g., the goods deck 130DG (see FIG. 1) and are positioned on the frame 262F so that the mobile robot 262 remains stable (e.g., does not tip laterally or longitudinally and/or all wheels of the mobile robot 262 remain in contact with a riding surface (such as of the goods deck 130DG) on which the mobile robot 262 traverses) for receiving breakpack goods BPG to the payload bed 310, dispensing breakpack goods BPG from the payload bed 310, and traversal of the goods deck 130DG.

The mobile robot 262 includes any suitable feedback devices (such as a vision system) connected to the controller 262C. The feedback devices includes at least one sensor PS1, PS2 that effect(s), with the controller 262C, one or more of goods bot localization/navigation within the breakpack module 266 and object detection. The at least one sensor PS1, PS2 is/are inclusive of, but is/are not limited to, any suitable camera(s). The object detection may be one or more of detection of objects on the goods deck 130DC (e.g., detection of other goods bots and/or debris, etc.), detection of a battery 289 as described herein, detection of guide wall 900 on the automatic battery charging/swapping station 130C, detection of objects at the interface 263 (e.g., goods containers, breakpack goods BPG within a goods container 264, etc.), detection of objects within the payload bed 310 of the mobile robot 262 (e.g., breakpack goods within the payload bed 310, etc.), or any other suitable object on-board or off-board the mobile robot 262. At least one navigation sensor PSI is provided for one or more of effecting navigation of the mobile robot 262 and verifying engagement of the mobile robot 262 to the automatic battery charging/swapping station 130C. Suitable examples of goods bot sensors (vision system) and their operation are described in U.S. provisional patent application No. 63/452,735 filed on Mar. 17, 2023, the disclosure of which was previously incorporated herein by reference in its entirety.

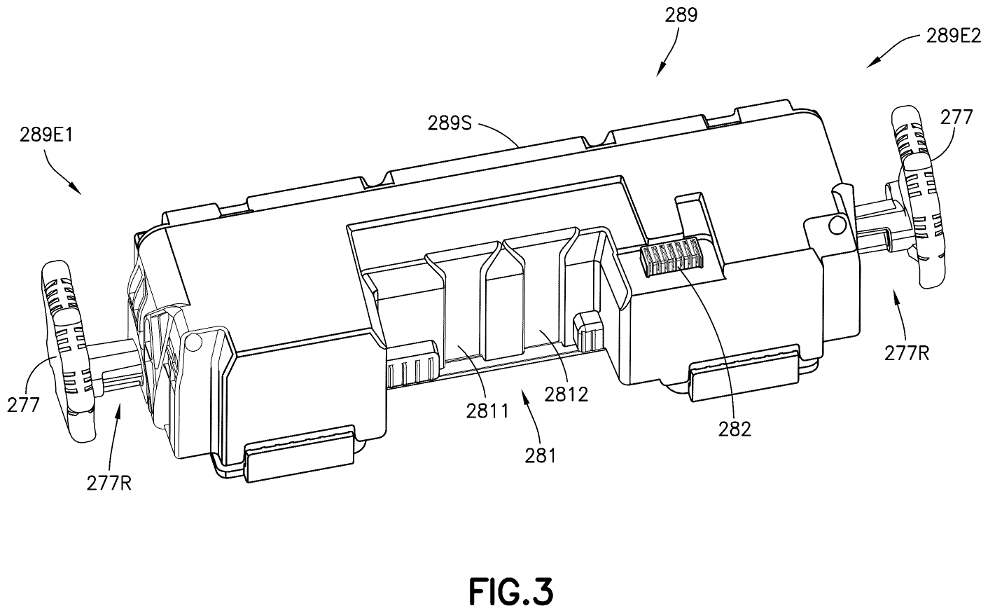

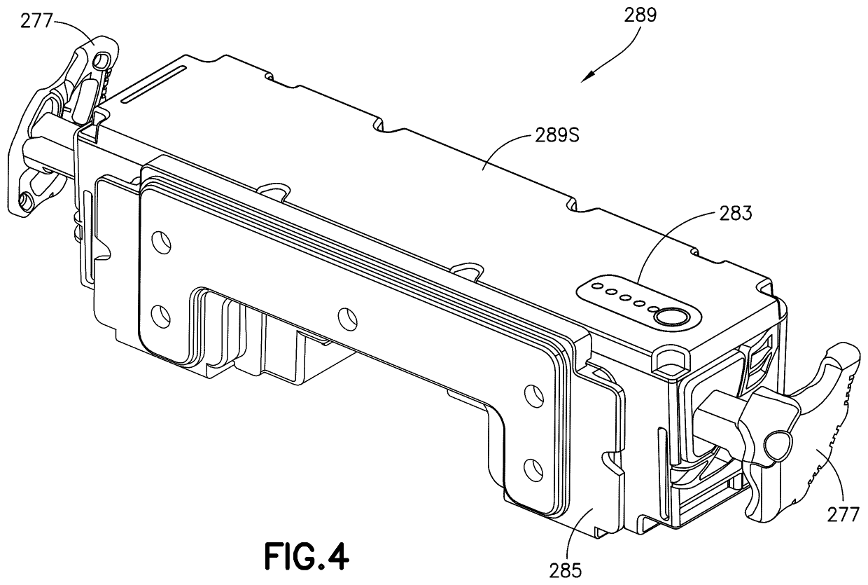

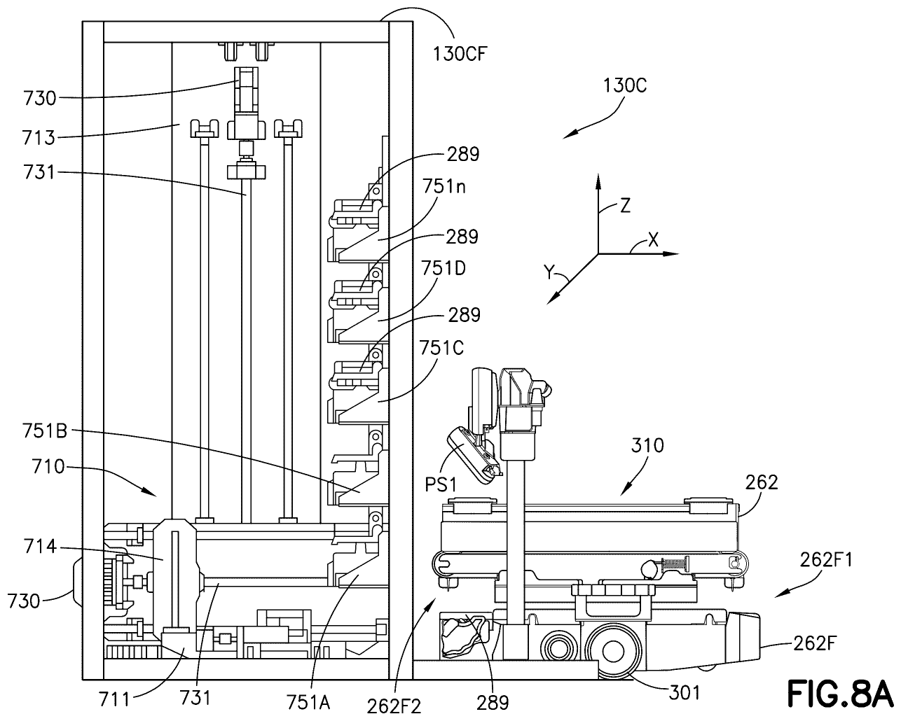

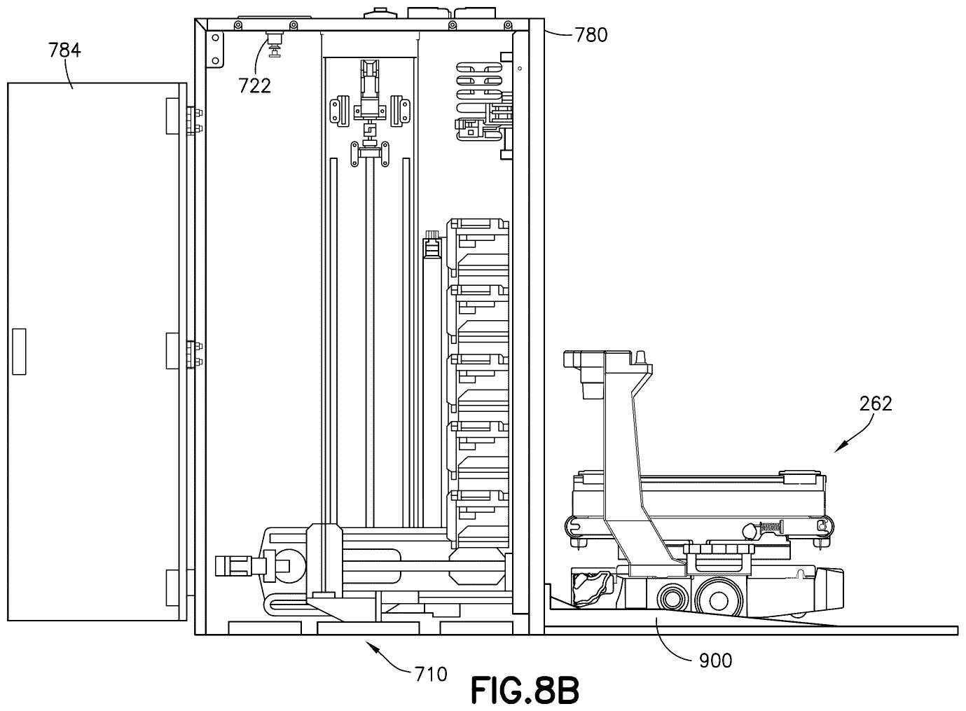

Referring to FIGS. 2A, 3-4, and 5-6, the mobile robot 262 may be powered by one or more power source (battery 289) that can be quickly and automatically exchanged/swapped for a stored battery (new or recharged) at the automatic battery charging/swapping station 130C as described herein. The battery 289 is configured to provide power to the mobile robot 262 to allow the mobile robot 262 to operate within the automated storage and retrieval system 100. For example, the battery 289 may be used to provide power for operation of the wheels 301, electronics, actuators 262E, sensors PS1, PS2, etc. on the mobile robot 262. The battery 289 is rechargeable such that the battery storage location(s) 750A-n (FIGS. 7A and 8A) located at the automatic battery charging/swapping station 130C recharges the battery 289 after it is depleted during operation of the mobile robot 262. Example types of rechargeable batteries that may be used include lithium ion batteries, NiMh batteries, NiCD batteries, NiZn batteries, and AgZn batteries or any other type of rechargeable batteries.

The battery 289 is comprised of an outer shell 289S including, at least, aligning features 281 (e.g., linear guide slots 2811, 2812), a status indicator 283, electrical contacts 282, and one or more handles 277. In some aspects, the battery 289 may include a robotic gripper interface 285. It is understood that the battery 289 may include fewer or more components than those illustrated here, and certain components may also be combined or divided in any way. The outer shell 289S is shaped and sized depending on a configuration of, e.g., the battery bay or interface 275 of the mobile robot 262. For example, the outer shell 289S extends a predetermined distance D from a first end 289E1 to a second end 289E2 and is configured to fit into the battery bay 275 on the mobile robot 262. The status indicator 283 is configured to provide a visual indication of a charge state of the battery 289 to human operators. In some aspects, the battery 289 has unique indicia, and the control server 120 includes information regarding the identification and location of each of the batteries. For example, each of the batteries 289 may include an identification tag having the unique identification of the battery 289, and at least one of the automatic battery charging/swapping station 130C and mobile robot 262 may have an identification tag reader (for example, the feedback sensor PSI of the mobile robot 262).

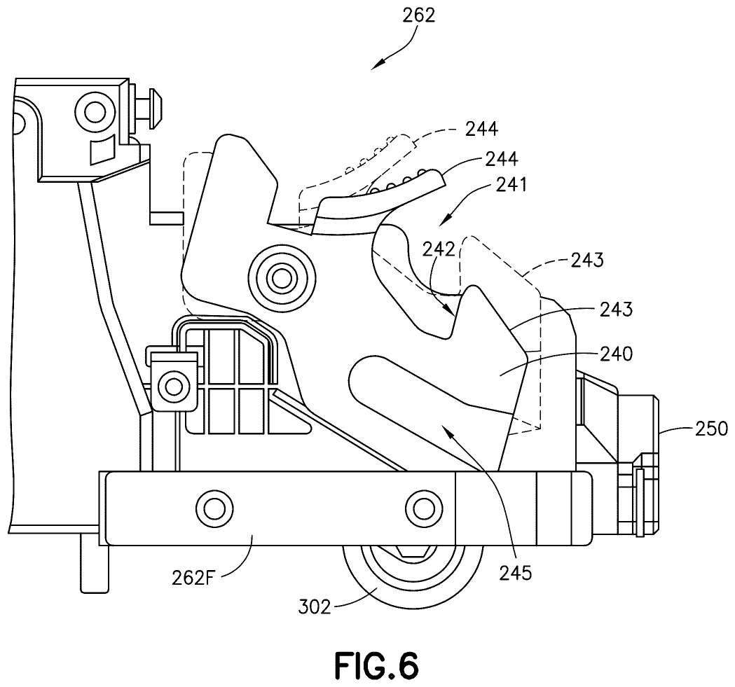

The one or more handles 277 of the battery 289 are configured for retaining, handling, and porting (carrying transport) of the battery 289. The one or more handles 277 may be extensions that extend from either end 289E1, 289E2 of the battery shell 289S. In one aspect, each handle 277 may include a post, tab, or rail 277R shaped and sized so as to effect capture of the battery 289 on the mobile robot 262 or a battery storage location 750A-n. The one or more handle 277 may also be configured so that a human operator can grip the handle 277 for lifting and porting the battery 289. Each handle 277 may be coupled to the battery shell 289S in any suitable manner. For example, the handle(s) 277 may be fixed to the battery shell 289S with any suitable mechanical or chemical fasteners (e.g., welding, brazing, bolts, etc.). As seen in FIGS. 5 and 6 and further described below, the battery interface 275 of the mobile robot 262 is configured so that automatic capture and release of the battery 289 to and from the mobile robot 262 is effected via automatic engagement between the battery 289 and an end effector 711 extended outside the automatic battery charging/swapping station 130C. The mobile robot 262 includes retention and release mechanisms (i.e., latches 240 and bias springs 249) to mate with and secure the one or more conformal post(s), tab(s), or rail(s) 277R (here illustrated, for example, as part of handle(s) 277 by may extend from or is embedded in the battery in any suitable manner), capturing and retaining the battery 289 in the battery bay 275 of the mobile robot 262. Each latch 240 includes a groove 241 with a cam or ramp 243 and a catch or retaining surface 242. The one or more post(s) 277P (of handle(s) 277) is configured (has a cooperating cam surface) to engage the cam or ramp 243 to bias the latches 240 in direction 998 in order to “open” the latch for the handle to enter the groove 241. During engagement, once the maximum displacement is reached on the cam or ramp 243, the post(s), tab(s), or rail(s) 277R enters the groove 241. With the post(s), tab(s), or rail(s) 277R in the groove 241, the spring 249 biases the latches 240 in bias direction 999. The one or more post(s), tab(s), or rail(s) 277R is captured against the retaining surface 242 resulting in the battery 289 being retained in the battery bay 275 of the mobile robot 262. Each latch 240 may further include a manual release 244 and/or an automated release groove 245. The manual release 244 is a lever that is depressed by a human operator in order to bias the spring 249 in the direction 998 to release the battery 289 from retention. The automated release groove 245 is configured to mate with an automatic battery swapping mechanism 710 to automatically release the battery 289 from retention in the battery bay 275 as will be further described below. Automatic capture and grip is effected upon insertion, substantially coincident with insert and is automatically effected in one move (battery insertion) and one-step (no separate capture/handling action from insertion action). Conversely, disassembly or removal of the battery from the battery interface 275 is effected in one move/step.

As noted above, the battery 289 includes battery alignment features 281 (e.g., linear guide rails 2811, 2812) to mate with battery bay alignment features 250 (e.g., linear slots 2511, 2512) on the mobile robot 262. The battery alignment features 281 and the battery bay alignment features 250 mating effect alignment of the battery electrical contact 282 with a robot electrical contact 260 to provide power to the mobile robot 262.

Referring now to FIGS. 1 and 7A-9D as noted above, each mobile robot 262 is provided with a battery 289. The battery 289 provides power to the mobile robot 262 as the mobile robot 262 operates within the automatic storage and retrieval system 100. When the battery 289 is depleted (i.e., reaches a predetermined charge state), the mobile robot 262 may navigate to the automatic battery charging/swapping station 130C. Each storage level 130L may include at least one automatic battery charging/swapping stations 130C for charging/swapping the battery 289 of a corresponding mobile robot 262 as will be described herein (although described with respect to swapping batteries of the mobile robot 262, the described features and methods of the automatic battery charging/swapping stations 130C can be utilized on any mobile vehicle/robot, including, e.g., container bot 110, with slight modifications depending on size, shape, etc.).

Some or all of the mobile robots 262 may periodically swap an on-board battery with a stored battery (new or recharged) from the automatic battery charging/swapping station 130C equipped with multiple battery storage locations 750A-n. In particular, the automatic battery charging/swapping station 130C may replace drained batteries with new or recharged batteries, which makes it unnecessary for robots to sit idle and wait for batteries to charge on-board at a charging station. For example, a mobile robot 262 with a weak battery may be controlled to move to the automatic battery charging/swapping station 130C where the battery 289 is “pulled” from the battery bay 275 of the mobile robot 262, and replaced with a fresh battery from the automatic battery charging/swapping station 130C. In this manner, the mobile robot 262 is provided with a new or recharged battery with potentially substantially less down time than where a battery is charged at a charging station with the battery 289 on-board the battery bay 275 of the mobile robot 262.

In some aspects, battery exchanges may be scheduled by the warehouse management system 2500. For example, individual mobile robots 262 may be configured to monitor their battery charge status. The mobile robots 262, via the controller 262C, may periodically send information to the warehouse management system 2500 indicating the status of the respective battery. This information may then be used by the warehouse management system 2500 to opportunistically schedule battery replacements for individual robots within the fleet, when needed or convenient. In other aspects, the mobile robot 262 may be configured to proceed to exchange one or more batteries on a preset schedule, or when a battery reaches a preselected discharge state.

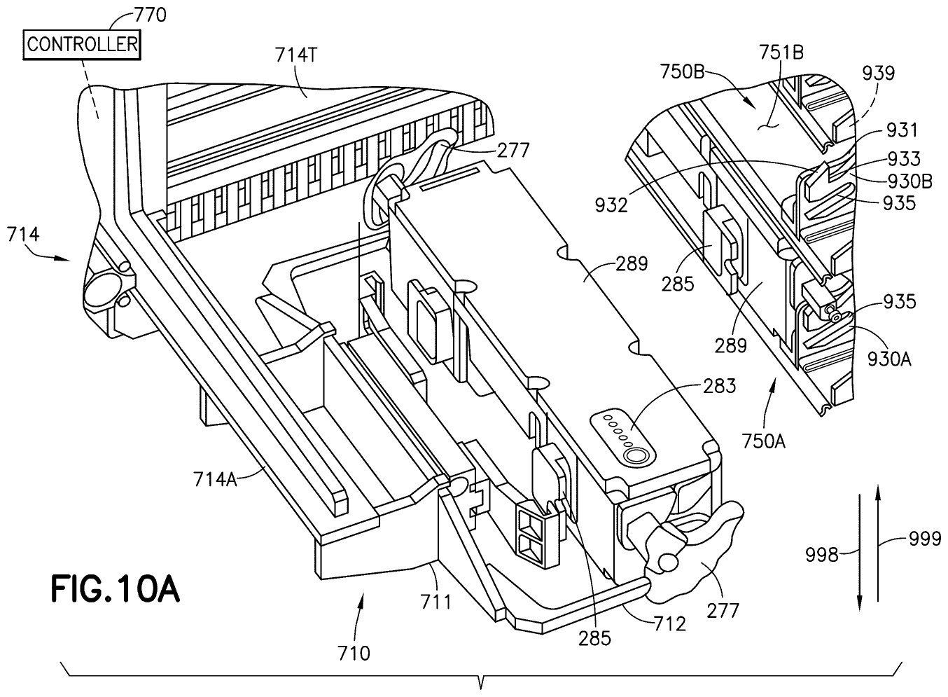

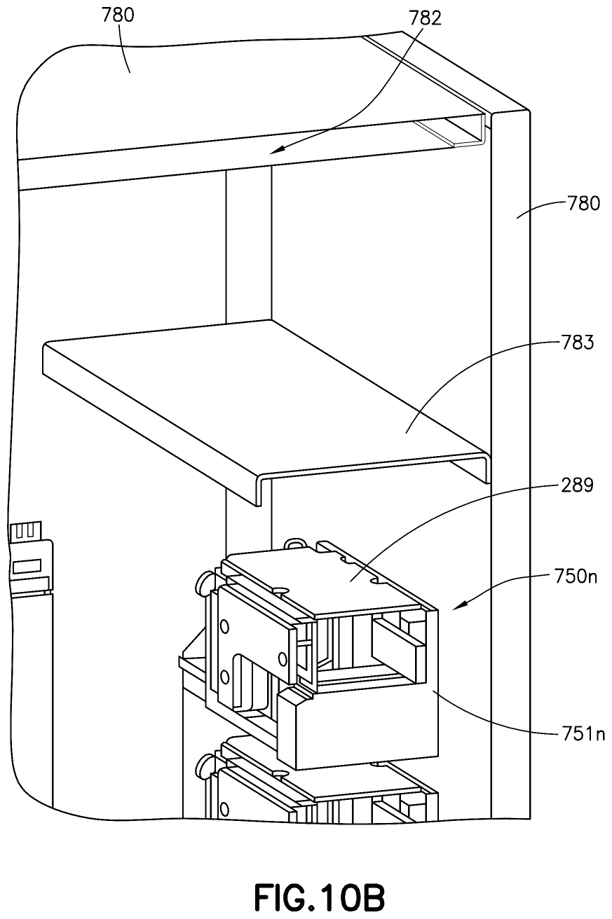

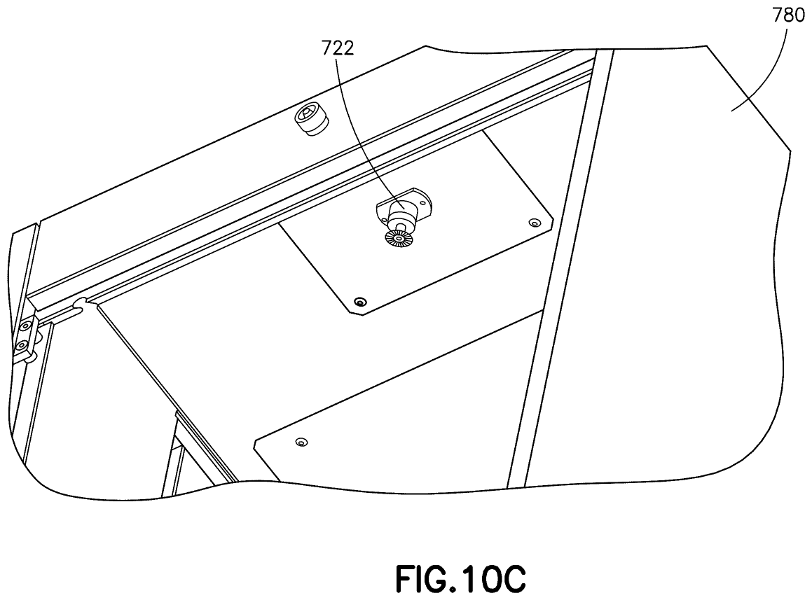

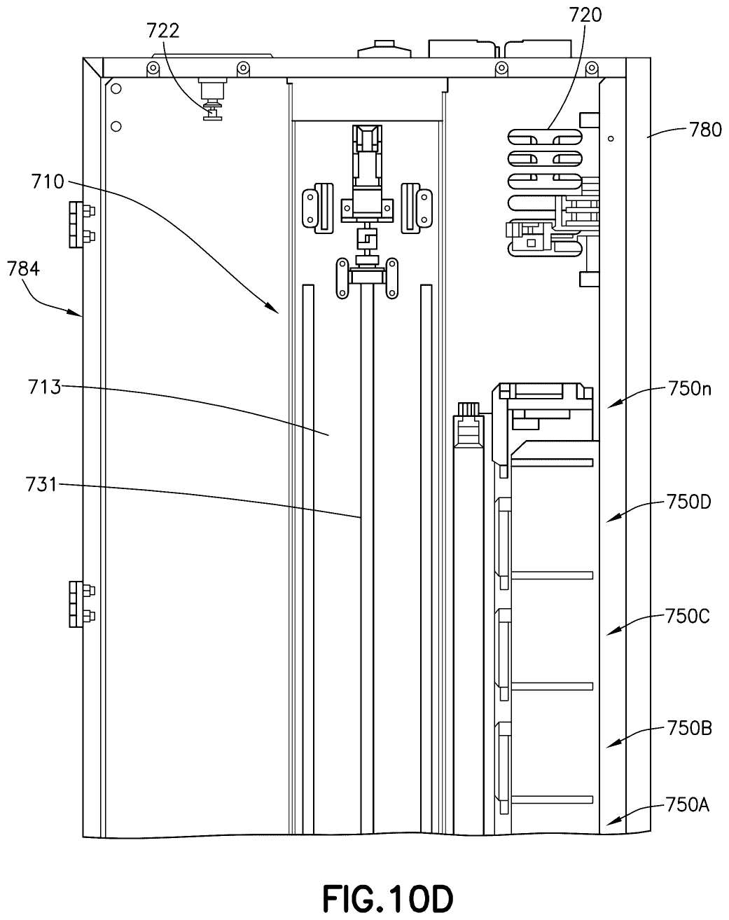

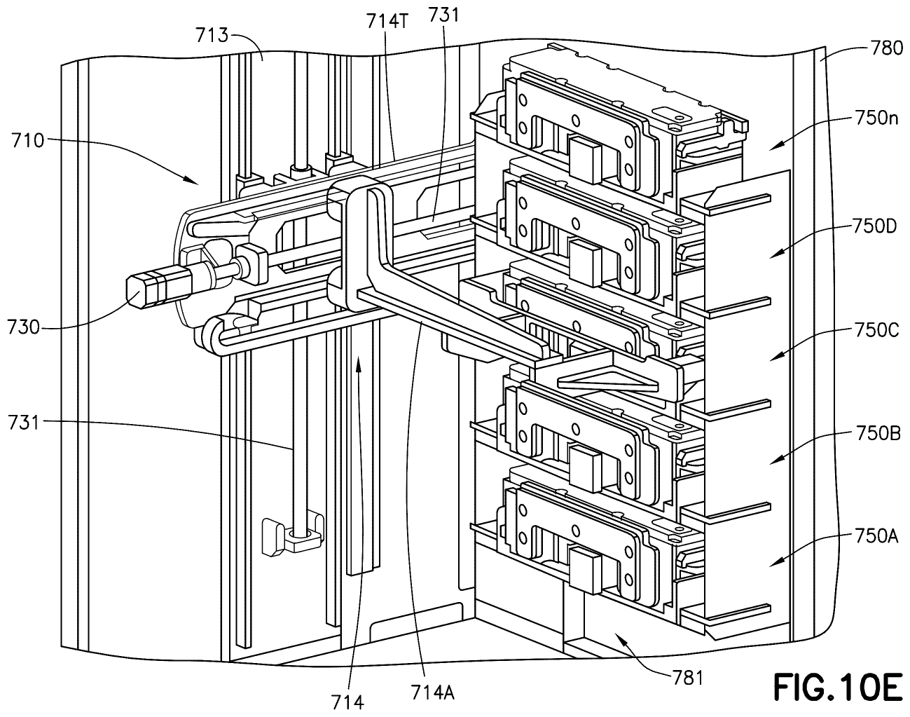

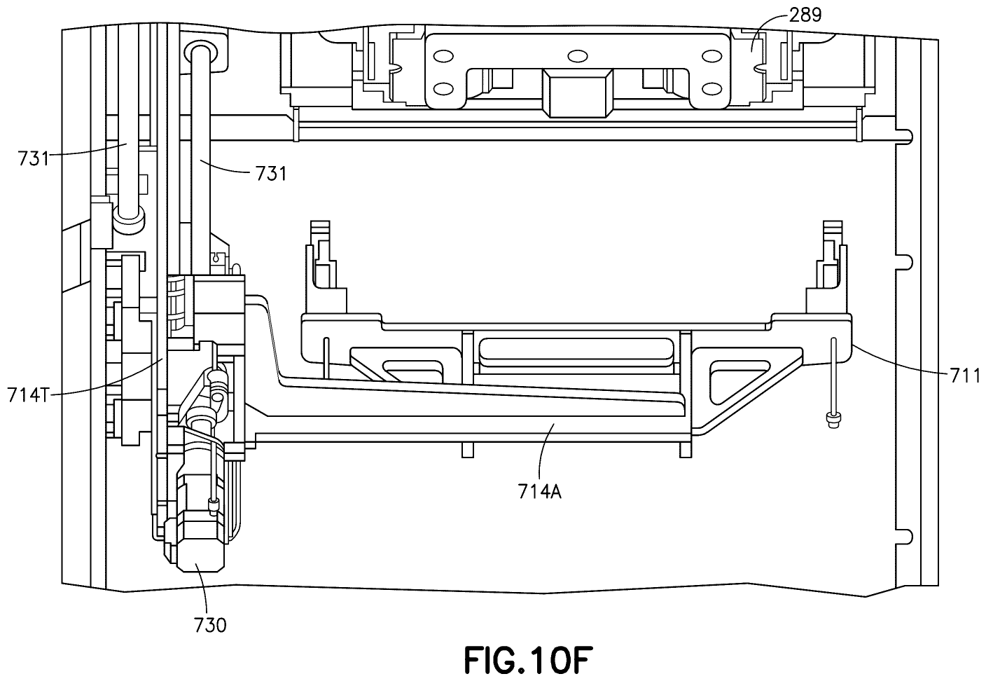

Still referring to FIGS. 1 and 7A-9D, the automatic battery charging/swapping station 130C comprises a frame 130CF (forming a housing closure or enclosure 780 with a configuration that is substantially closed so as to form exterior bounds of the internal space), a power supply 312, a controller 770, a battery swapping mechanism 710, and the battery storage 750 with an array of battery storage locations 750A-n adapted to support and charge a corresponding battery 289. The frame 130CF may be constructed from any suitable material (such as a fire resistant material (e.g., steel of specific thickness (e.g., 1.5 mm) with at least a 2-hour fire resistant rating)) and may be any suitable dimensions (height H, width W, and depth DT). The dimensions may be dependent on a number of factors, such as, e.g., the number of batteries held within the housing closure 780, size and types of battery, fire resistant standards, etc. For example, as seen in FIG. 10B, in some aspects, the enclosure 780 is assembled from double walled panels of 1.5 mm thick cold rolled steel. An air gap 782 between inner and outer skins provides insulation, and further insulation material can be added to each panel. The enclosure 780 includes a maintenance door 784, which may be located on any panel of the enclosure (e.g., the rear as illustrated) with latches and hinges made of any suitable material (such as stainless steel).

The housing closure 780 further includes a narrowed opening 781 at the bottom 780B of the housing closure 780 adjacent a drive surface of the mobile robot 262 outside the station. The narrowed opening 781 forms access from inside the housing closure 780 to the battery 289 of the mobile robot 262 outside the automatic battery charging/swapping station 130C, so that the housing closure 780 provides a predetermined fire resistant criteria to the automatic battery charging/swapping station 130C. The narrow opening 781 is sized and shaped to substantially conform to the space envelope of the battery passing through the narrowed opening, with minimal clearance and so that in combination with closure 780 surrounding the narrow opening 718 the station provides the predetermine fire resistant criteria. The narrow opening 781 may include a fire door 781D that closes in the event of a thermal event. The fire door 781D is held in an open position by a heat-activated fusible link 781L. The heat-activated fusible link 781L is configured to break when the temperature reaches a predetermined threshold in the enclosure. The housing closure 780 may also include a fire detection and suppression system 721 and a vent 720. The fire detection and suppression system 721 has, for example, a sprinkler head 722 (K17, K25, etc.) to keep temperatures down and deal with open flames. A fusible seal may seal the sprinkler such that the sprinkler will be activated when the ambient temperature reaches a predetermined threshold in the enclosure. In some aspects, the housing closure 780 is a unit shell. The enclosure 780 may further include a shelf 783, which may be a buffer shelf or a stand-alone shelf without charging capabilities where a battery 289 may be stored.

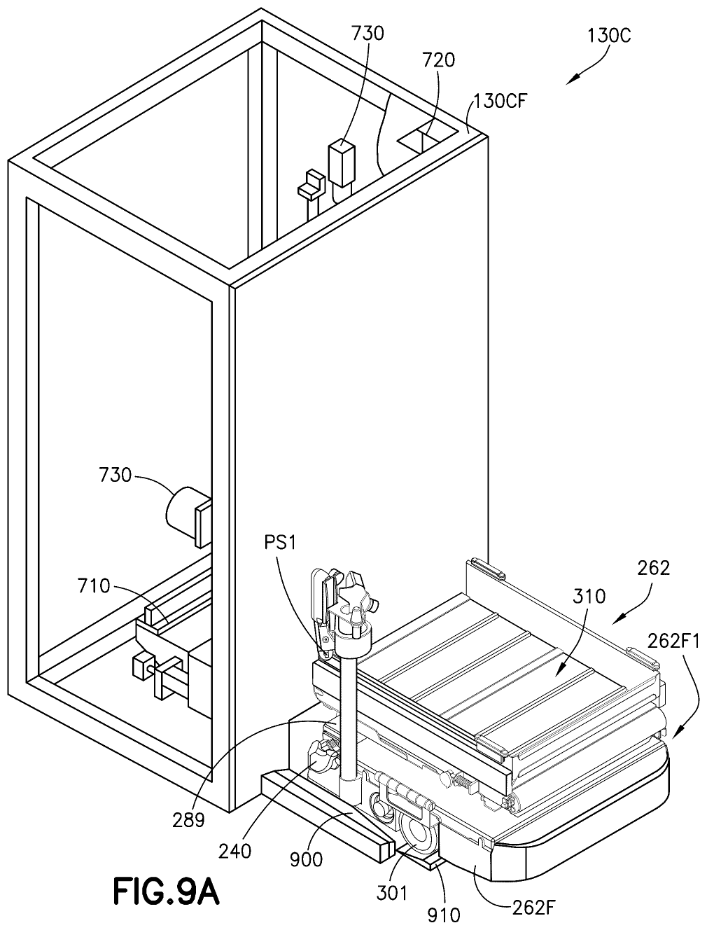

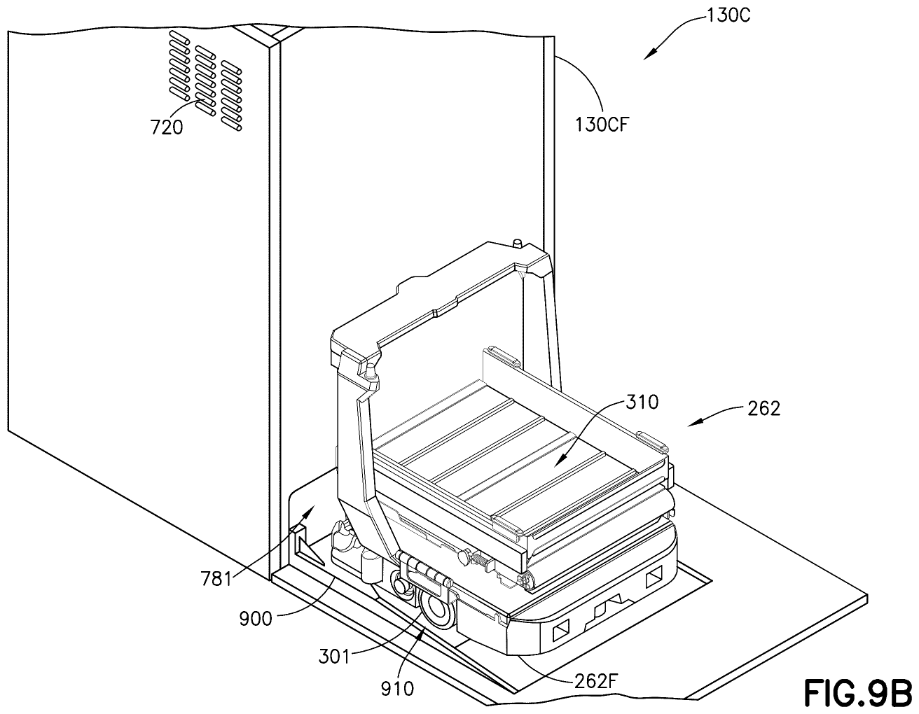

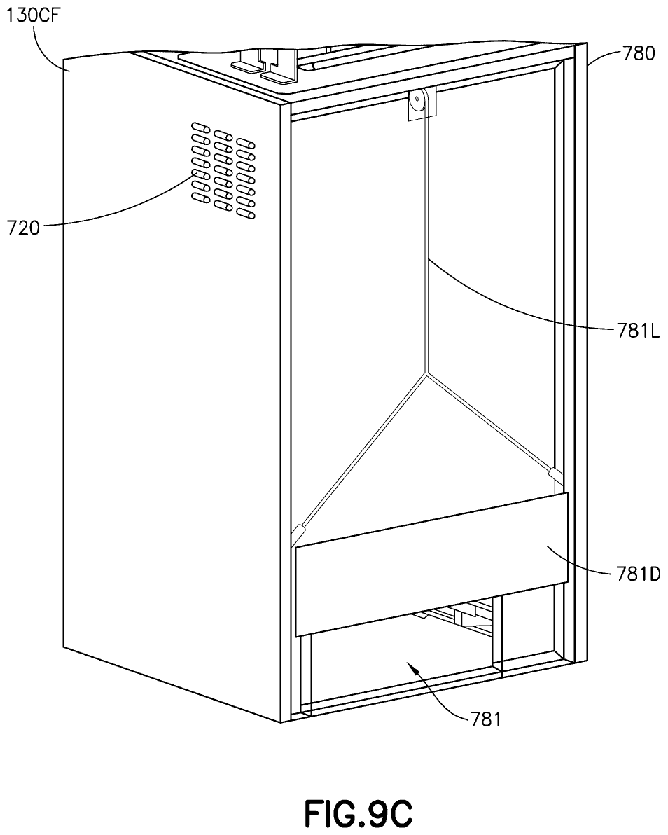

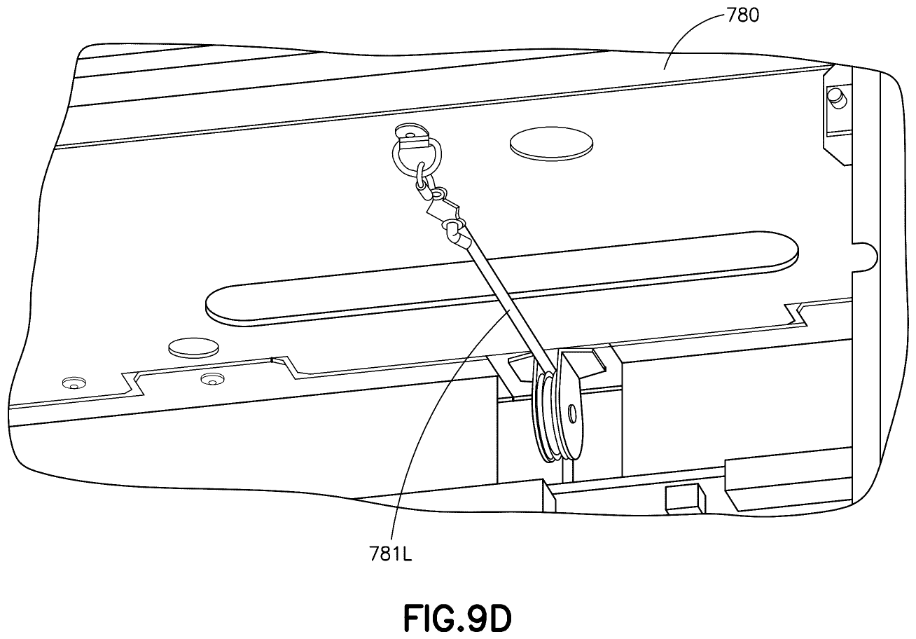

The automatic battery charging/swapping station 130C may further comprise one or more docking features (e.g., structural guide walls 900) configured to assist with aligning the mobile robot 262 to enable battery exchanges to take place. Such docking features may electronically and/or mechanically trigger commencement of a battery exchange process. Any suitable docking features may be used, including but not limited to structural, mechanical, magnetic, inductive, conductive, and/or optical features. For example, FIGS. 8A and 9A illustrate a docking feature as a structural guide wall 900 to guide the mobile robot 262 into engagement with the automatic battery charging/swapping station 130C. It will be understood that the mobile robot 262 may include docking features complementary to docking features of the automatic battery charging/swapping station 130C (for example bumpers). The automatic battery charging/swapping station 130C may further include restraining features to restrain the mobile robot 262 during the battery exchange process. For example, wheel chocks 910 (FIG. 9A) or any other suitable mechanism may be provided to hold the mobile robot 262 in place.

As noted above, the automatic battery charging/swapping station 130C includes the battery storage 750 with an array of battery storage locations 750A-n distributed inside the housing closure 780. The automatic battery charging/swapping station 130C may have any suitable number of battery storage locations 750A-n in the array depending on, e.g., the height H of the housing closure 780 for charging depleted batteries and storing charged batteries until they are needed. For example, as illustrated, there are five (5) battery storage locations, but there may be more or less consistent with fire resistant standards and desired capacity of the automatic battery charging/swapping station 130C. The battery storage locations 750A-n may have any suitable configuration for retaining a battery and connecting the battery to electrical contacts 920 configured to form a conductive path with complementary contacts 282 contained on the battery 289. It will be understood that the embodiment of FIGS. 7A-13E are presented for the purpose of example, and are not intended to be limiting in any manner, as features including but not limited to alignment, guides, contacts, etc. may have any suitable configurations.

At the automatic battery charging/swapping station 130C, the battery 289 in the battery bay 275 of the mobile robot 262 is removed from the mobile robot 262 and attached to an available battery storage location 750A-n. Each battery storage location 750A-n may comprise, at least, supports 751A-n, an electrical contact 920, and retention and release mechanisms 930A-n (in some aspects, substantially similar to the latches 240 described above). In some aspects, the automatic battery charging/swapping station 130C may include multiple different types of battery storage locations for different battery types of different robots (110, 262, etc.) within a fleet. For example, smaller battery storage locations may be used to charge batteries for mobile robots 262 while larger battery storage locations may be used to charge batteries for container robots 110.

Each battery storage location 750A-n includes supports 751A-n configured to support a battery being charged or stored (awaiting deployment) at the corresponding battery storage location 750A-n. The supports 751A-n may be any suitable support, such as a shelf, that is arranged, shaped, and sized to hold and carry the weight of a respective battery. The retention and release mechanisms 930A-n are configured to mate with and secure the battery on the respective support 751A-n substantially similar to the latch 240 described above. In one aspect, the retention and release mechanisms 930A-n are configured to mate with and secure the one or more post(s), tab(s), or rail(s) 277R, thereby capturing the battery 289 on a corresponding battery storage location 750A-n. As seen in FIG. 10A, each retention and release mechanisms 930A-n includes a groove 931 with a cam or ramp 932 and a catch or retaining surface 933. The one or more post(s), tab(s), or rail(s) 277R is configured to engage the cam or ramp 932 to bias the retention and release mechanisms 930A-n in direction 998 in order to “open” the mechanism for the post(s), tab(s), or rail(s) 277R to enter the groove 931. During engagement, once the maximum displacement is reached on the cam or ramp 932, the post(s), tab(s), or rail(s) 277R enters the groove 931. With the post(s), tab(s), or rail(s) 277R in the groove 931, a spring 939 biases the retention and release mechanisms 930A-n in bias direction 999. The one or more post(s), tab(s), or rail(s) 277R is captured against the retaining surface 933 resulting in the battery 289 being retained in the corresponding battery storage location 750A-n. Each retention and release mechanisms 930A-n may further include a manual release and/or an automated release groove 935. The automated release groove 935 is configured to mate with the battery swapping mechanism 710 to automatically release the battery 289 from retention in the corresponding battery storage location 750A-n as will be further described below

Still referring to FIG. 10A, the battery swapping mechanism 710 is configured to automatically swap/exchange a stored battery (i.e., a new or recharged battery), on the station 130C, with a depleted or discharged battery, on the mobile robot 262. Thus, the mobile robot 262 is free to continue operation, being powered by the new or recharged battery, while the depleted or discharged battery is stored/charged in the automatic battery charging/swapping station 130C. In this manner, the mobile robot 262 may obtain a charged battery with less downtime than if the battery were recharged while in the mobile robot 262, and without human intervention. The automatic battery swapping mechanism 710 is disposed inside the housing closure 780, and includes a drive section 715, and an end effector 711 (also referred to as a gripper). The automatic battery swapping mechanism 710 is arranged to move between at least one of the battery storage locations 750A-n and outside the automatic battery charging/swapping station 130C so as to swap the battery of the mobile robot 262 (outside the automatic battery charging/swapping station 130C) with a stored battery in the at least one of the battery storage locations 750A-n through the narrowed opening 781. The drive section 715 provides the automatic battery swapping mechanism 710 with at least one degree of freedom of movement. The end effector 711 is configured to handle the battery so that the battery is moved by the automatic battery swapping mechanism 710, relative to the automatic battery charging/swapping station 130C, in the at least one degree of freedom.

In one aspect, the automatic battery swapping mechanism 710 has a mounting frame 713 and transfer chassis 714 dependent from the mounting frame 713. The drive section 715 is connected to the mounting frame 713 and operably connected to the transfer chassis 714. In one aspect, the transfer chassis 714 includes a traverse carriage 714C and arm 714A with the end effector 711. In other aspects, the transfer chassis 714 may be a multi-link arm with an end effector, or any other suitable transfer mechanism. In one aspect, the mounting frame 713 is juxtaposed proximate the array of battery storage locations 750A-n, so that the automatic battery swapping mechanism 710, positioned by the mounting frame 713, is proximate the array of battery storage locations 750A-n.

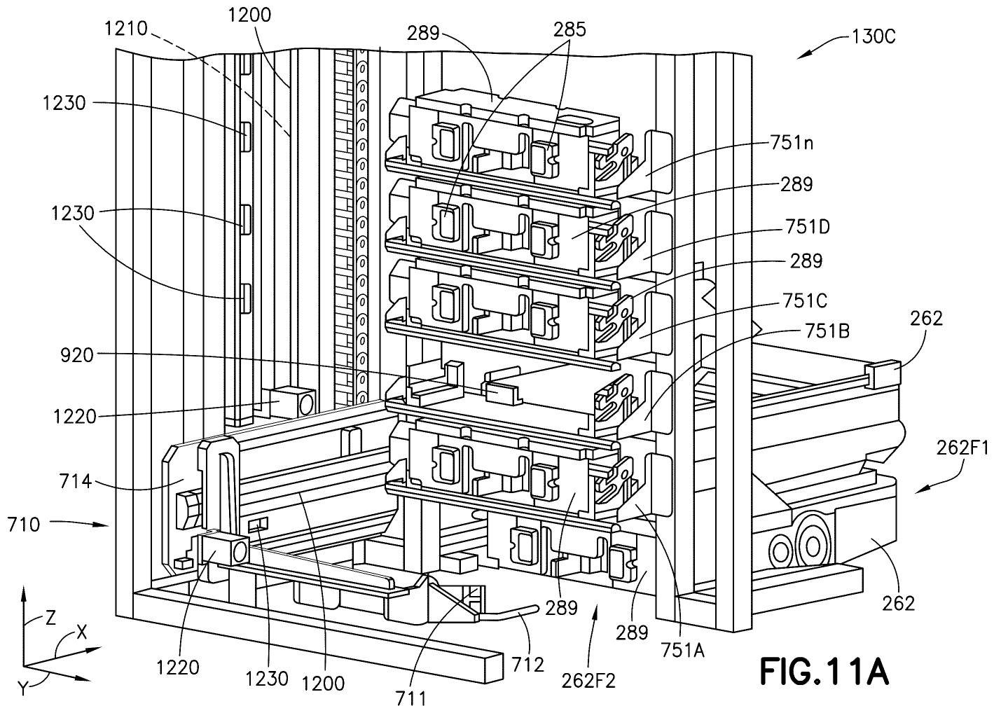

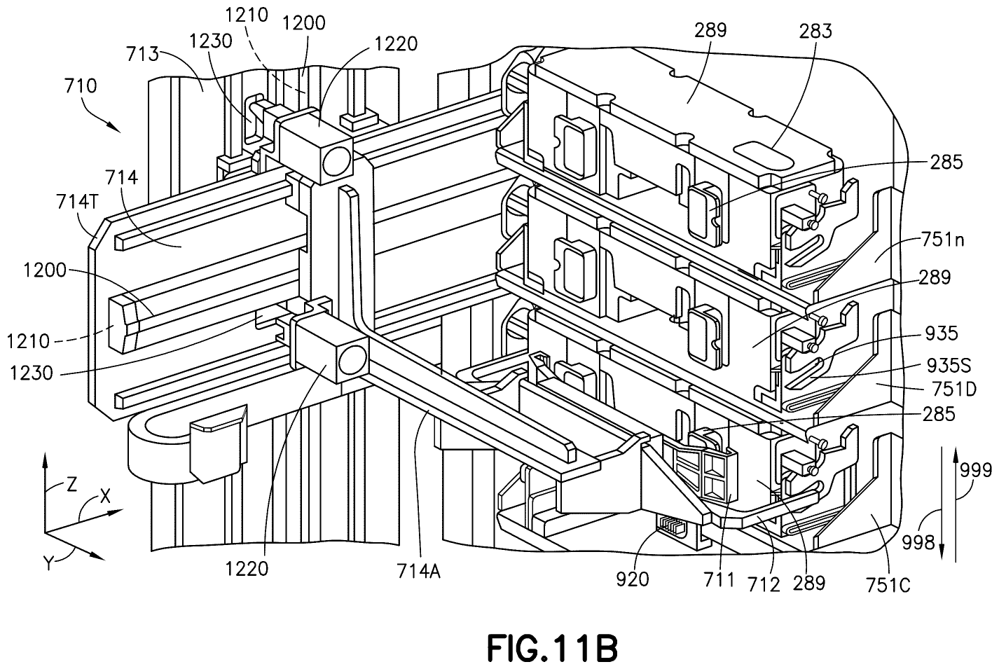

The battery swapping mechanism 710 may be controlled, via controller 770, to select a replacement battery and attach the replacement battery to the mobile robot 262. For example, mobile robot 262 with battery 289 that is weak may be controlled to navigate to the automatic battery charging/swapping station 130C where the battery swapping mechanism 710 pulls the battery from the mobile robot 262, attaches the battery to an available battery storage location 750A-n, and provides the mobile robot 262 with a new or recharged battery. For example, the battery swapping mechanism 710 may include the end effector 711 to interface with the robotic gripper interface 285 of the battery 289. The battery swapping mechanism 710 further includes a release mechanism 712 to interface with the retention and release mechanisms 930A-n on the battery storage locations 750A-n or latches 240 on the mobile robot 262. As seen in FIG. 11B, when removing the battery 289, the battery swapping mechanism 710 is configured to position the release mechanism 712 within the automatic release groove 935 of the retention and release mechanisms 930A-n. The automatic release groove 935 has a cam surface 935S that is interfaced by the release mechanism 712 to bias the retention and release mechanisms 930A-n in the direction 998 to release the battery from retention (it will be understood be those skilled in the art that where the battery removal occurs on the mobile robot 262, latches 240 will operate in the same manner as retention and release mechanisms 930A-n).

As noted above, the battery swapping mechanism 710 include the drive section 715, which provides the battery swapping mechanism 710 with at least one degree of freedom. In one aspect, the drive section 715 is a 3-drive axis drive section defining three degrees of freedom of the automatic battery swapping mechanism 710 (e.g., lift (z), extension (x) and/or grip (y)). As illustrated in FIGS. 7A-8B, the motion may be imparted via motors 730, pneumatic cylinders 1200 (FIGS. 11A-11B), or any other suitable actuators. As illustrated in at least FIG. 7A, the motors 730 are coupled to ball screws 731 to convert the rotational motion of the motor into linear motion (e.g., lift (z) or extension (x)). It is noted that although ball screws are illustrated, the transmission system may be any suitable transmission, such as belts. The motor 730 may include any suitable encoder 732 and sensors 733 to determine position of the battery swapping mechanism 710. The battery swapping mechanism 710 may include a counterweight 735 to reduce the load while transporting the battery 289. Alternatively, referring to FIGS. 11A-11B, the battery swapping mechanism 710 may be a pneumatic lift, where motion is imparted via pneumatic cylinders 1200. The battery swapping mechanism 710 may further include a pneumatic stopper 1220 that extends when the pneumatic lift is at a predetermined position (i.e., at a specific support 751A-n). The pneumatic stopper 1220 extends into a cutout 1230 on the lift plate. There may be sensors 1210 along the pneumatic cylinder 1200 to determine position of the battery swapping mechanism 710.

Referring again to FIGS. 1 and 7A-9D, the controller 770 is configured to effect the battery exchange process. For example, the controller 770 may include executable instructions (any suitable non-transitory computer readable code) stored thereon to perform tasks related to exchanging batteries with the mobile robot 262. The controller 700 may also automate battery management strategies. As noted above, each battery 289 may have indicia (such as a barcode) so that the controller 770, via any sensor, can identify individual batteries. The controller 770 of the automatic battery charging/swapping station 130C may track how many times individual batteries have been recharged. The controller 770 may also keep track of which batteries have spent time in which mobile robots 262, how long the batteries took to recharge at the automatic battery charging/swapping station 130C in the past, and other relevant properties for efficient battery management. The battery usage information may be used by the controller 770 to select an optimal battery for the battery swapping mechanism 710 to give to particular mobile robots 262. In another aspect, the controller 770 of the automatic battery charging/swapping station 130C may automate battery management strategies in cooperation with the warehouse management system 2500 or the mobile robot controller 262C. The controller 770 may also be configured to determine which battery storage locations 750A-n to attach received batteries to, and which available batteries 289 at the exchange station 130C to provide to particular robots 262. The controller 770 identifies when batteries are ready for redeployment based on the battery being recharged. In further examples, controller 262C may also serve as an abstraction layer on top of a management system of battery 289. Controller 262C may facilitate access of battery state information by the mobile robot 262 carrying the battery 289 and/or the automatic battery charging/swapping station 130C. For example, controller 262C may monitor and report the state of battery 289, which may include information such as voltage, temperature, charge state, etc.

In one aspect, the automated storage and retrieval system 100 may include one central automatic battery charging/swapping station 130C which holds enough batteries to service the entire fleet of AGVs with limited downtime (for example, 30 or more batteries). In other aspects, the automated storage and retrieval system 100 includes multiple automatic battery charging/swapping stations 130C distributed throughout the system 100 so as to provide battery exchanges at various areas of the system 100. Here, the system 100 is designed to have redundant stations, where a mobile robot 262 may opportunistically swap batteries and where multiple mobile robots 262 may swap batteries at different stations at the same time. Moreover, upon a system restart, where multiple batteries in mobile robots 262 may have become drained (depletion occurring naturally over time as AGVs sit idle during shutdown), more battery exchange stations allows for a faster restart as multiple mobile robots 262 swap batteries at different, distributed stations at the same time. Additionally, more distributed battery exchange stations allows for the system 100 to operate at full capacity even in the event of one swap station becoming inoperable or in need of maintenance as the mobile robots may exchange at another station.

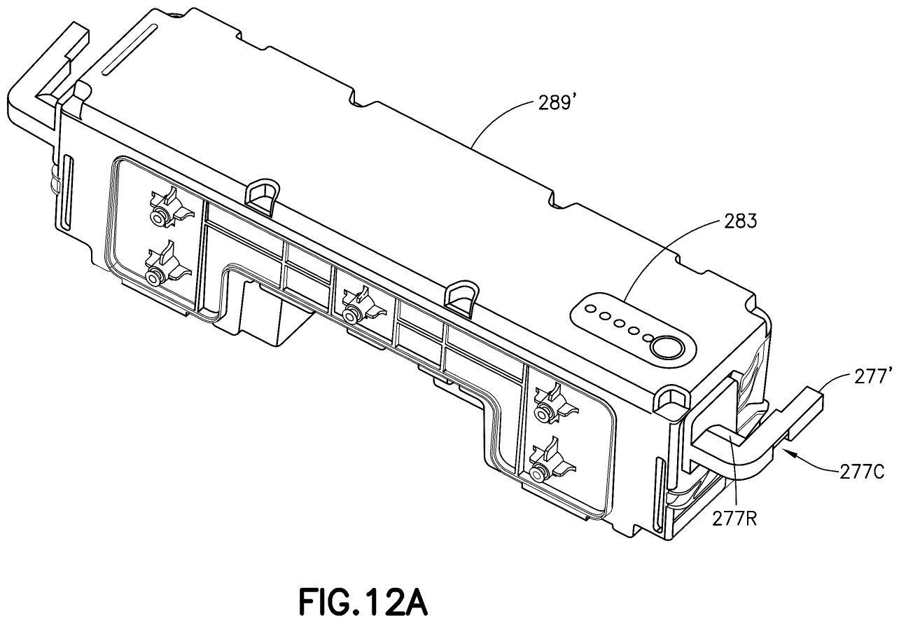

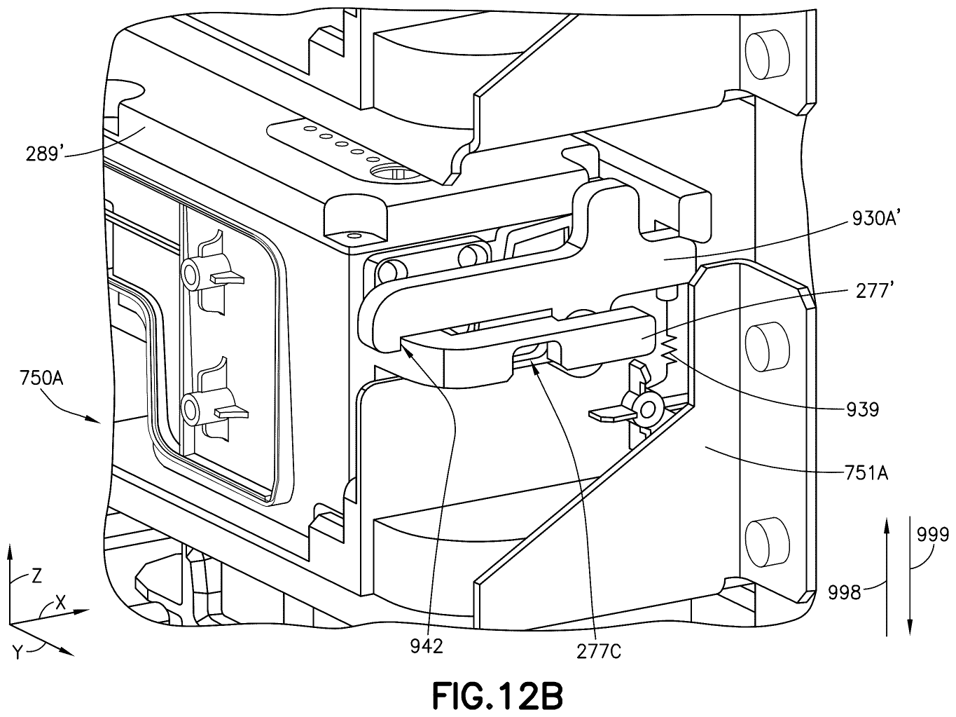

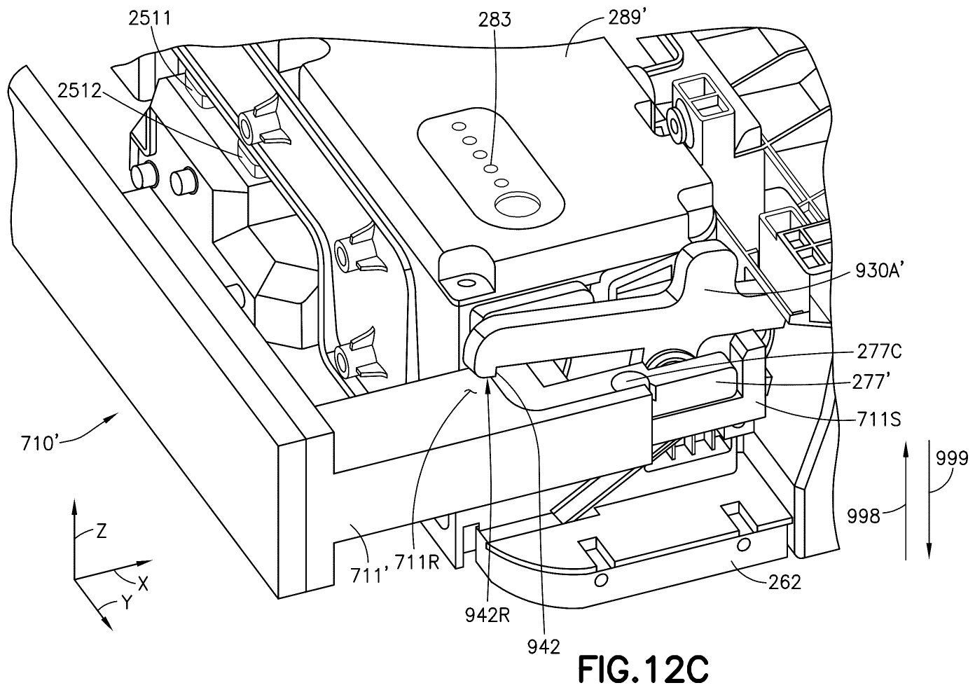

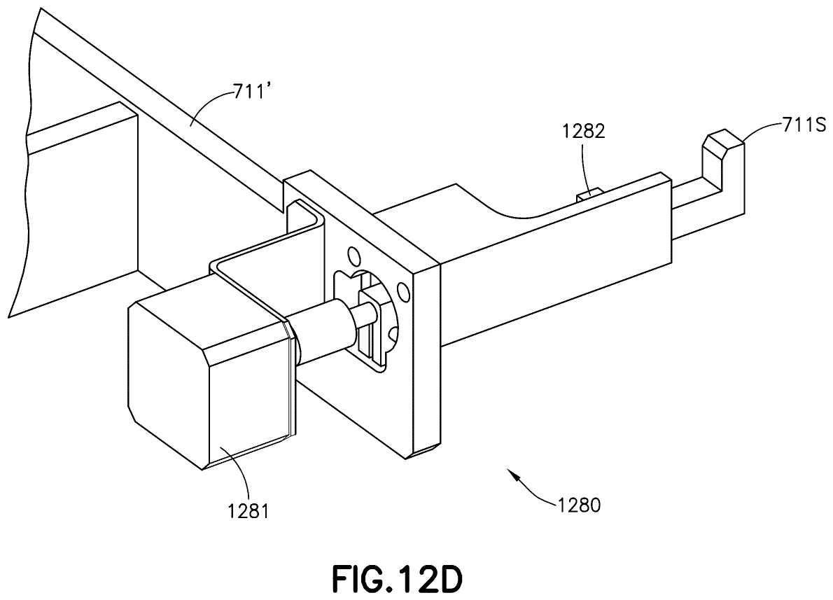

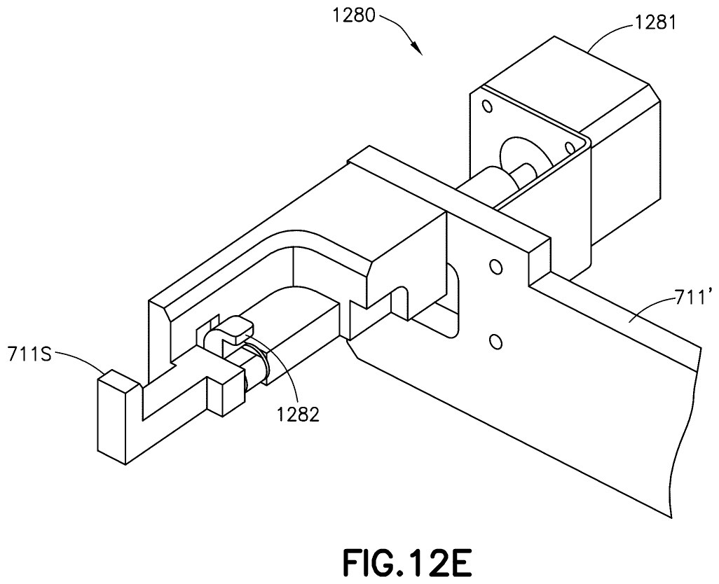

Referring to FIGS. 12A-12E, illustrated is an alternative configuration of the battery 289′ (i.e., the post(s) 277′) and battery swapping mechanism 710 (i.e., the end effector 711′). Here, the post(s) 277′ may include a cam or ramp 277R such that a clamp 930A′-n′ is configured to engage the cam or ramp 277R on the post(s) 277′ (vs the post(s) 277 engaging cam or ramp 243 on the latch 240). When the battery 289′ is inserted in the battery storage 750 in direction X, the clamp 930A′-n′ engages the cam or ramp 277R on the post(s) 277′, which biases the clamp 930A′-n′ in direction 998 (FIG. 12B). Spring 939 is configured to bias the clamp in direction 999 in order to “close” the clamp 930A′-n′. in the “closed” position, a catch or retaining surface 942 on the clamp 930A′-n′ engages the post(s) 277′ and prevents the battery 289 from shifting or moving on the support 751A of the battery storage 750 or the battery bay 275. To release the battery 289′, the end effector 711′ is extended under the post(s) 277′ in the x direction, then lifted in the z direction. As the end effector 711′ is lifted, a release surface 711R engages surface 942R of the clamp 930A′-n′ and biases the clamp 930A′-n′ in direction 998 to the “open” position. With the clamp 930A′-n′ in the “open” position, the battery 289′ is free to be pulled from the battery storage 750 or the battery bay 275. The end effector 711′ may further include a support extension 711S to support the post(s) 277′ and weight of the battery 289′. The end effector 711′ may further include a battery lock 1280 to prevent slipping of the battery from the support extension 711S. The battery lock 1280 includes an actuator 1281 (such as a stepper motor or solenoid) which actuates a locking tine 1282 to interface a cutout 277C on the post(s) 277′. The cutout 277C is shaped to prevent movement of the battery 289′ in the x direction during extension and retraction of the battery swapping mechanism 710 to remove or insert the battery 289′ in the battery storage 750 or the battery bay 275.

Referring to at least FIGS. 1, 7A-9D, and 13, a flowchart showing a method 1300 for operation of the station 130C is illustrated. Method 1300 may be carried out by any of the automatic battery charging/swapping station 130C illustrated and described previously with respect to FIGS. 7A-12E. Additionally, part or all of method 1300 may be carried out by a local control system 770 of the automatic battery charging/swapping station 130C or by the warehouse control system 2500. In further examples, method 1300 may be executed on a number of different possible types of mobile autonomous devices or vehicles as well.

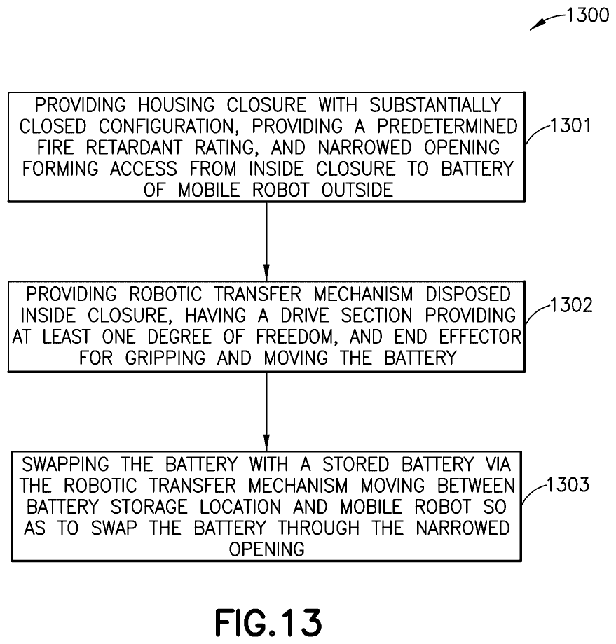

As shown by block 1301 of FIG. 13, method 1300 involves providing a housing closure 780, with a configuration that is substantially closed, enclosing the automatic battery swapping station 130C, with a narrowed opening 781, forming access from inside the housing closure 780 to the battery 289 of the mobile robot 262 outside the automatic battery swapping station 130C, the housing closure 780 providing a predetermined fire resistant criteria to the automatic battery swapping station 130C. The method 1300 also involves providing a robotic transfer mechanism 710 disposed inside the housing closure 780, the robotic transfer mechanism 710 having a drive section 715, providing the robotic transfer mechanism 710 at least one degree of freedom, and an end effector 711 for handling the battery 289 so that the battery 289 is moved by the robotic transfer mechanism 710, relative to the automatic battery swapping station 130C, in the at least one degree of freedom (FIG. 13, Block 1302). Swapping of the battery 289 of the automated guided vehicle robot 262 outside the automatic battery swapping station 130C with a stored battery from a battery storage 750A-n is effected via the robotic transfer mechanism 710 moving between at least one of the battery storage locations 750A-n and outside the automatic battery swapping station 130C so as to swap the battery 289 through the narrowed opening 781 (FIG. 13, Block 1303).

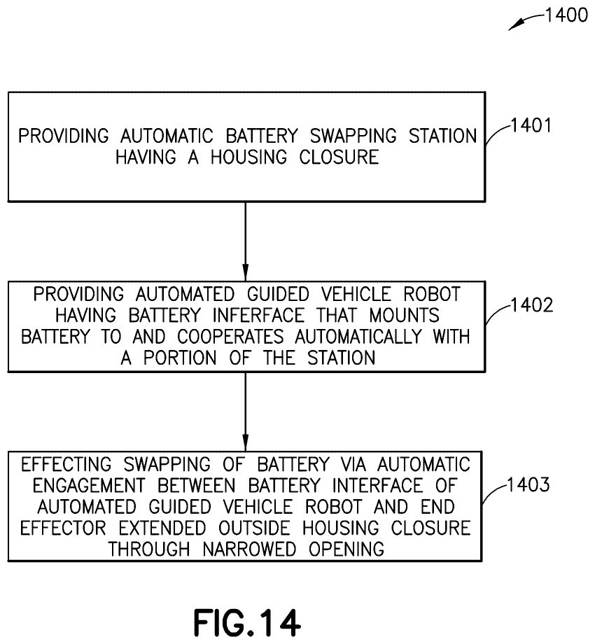

Referring also to FIG. 14, in some aspect, a method 1400 involves providing an automatic battery swapping station 130C having a housing closure 780, with a configuration that is substantially closed, enclosing the automatic battery swapping station 130C, with a narrowed opening 781, forming access from inside the housing closure 780 to the battery 289 of the automated guided vehicle bot 262 outside the automatic battery swapping station 130C, a robotic transfer mechanism 710 disposed inside the housing closure 780, the robotic transfer mechanism 710 having a drive section 715, providing the robotic transfer mechanism 710 at least one degree of freedom, and an end effector 711 for handling the battery 289 so that the battery 289 is moved by the robotic transfer mechanism 710, relative to the automatic battery swapping station 130C, in the at least one degree of freedom, and a battery storage 750 with an array of battery storage locations 750A-n distributed inside the housing closure 780 (FIG. 14, Block 1401). The method 1400 further involves providing the automated guided vehicle robot 262 having a battery interface 275 that mounts the battery 289 to the robot 262 and cooperates automatically with a portion of the swapping station 130C, wherein the robotic transfer mechanism 710 is arranged to move, via the at least one degree of freedom, between at least one of the battery storage locations 750A-n and outside the automatic battery swapping station 130C with a stored battery in the at least one of the battery storage locations 750A-n (FIG. 14, Block 1402). Swapping of the battery 289 is effected via automatic engagement between the battery interface 275 of the automated guided vehicle robot 262, configured for automatic capturing and release of the battery 289 to and from the automated guided vehicle robot 262, and the end effector extended outside the housing closure 780 through the narrowed opening 781 (FIG. 14, Block 1403).

The mobile robot 262 receives power from a battery 289 in order to operate within an environment. For example, the battery 289 provides power for the mobile robot 262 to navigate, for the control systems to function, for the sensors to receive sensor data during operation, etc. The mobile robot 262 may perform any number of different functions while operating with the battery 289. FIG. 2A illustrates an example of the mobile robot 262 carrying a battery 289 within a warehouse setting, according to an example embodiment. More specifically, mobile robot 262 may be provided with a battery 289 that may initially contain a fully charged battery. The mobile robot 262 may also have any number of different sensors for collecting information from the environment, such as sensors PS1, PS2.

The mobile robot 262 may be controlled to operate within the system 100. For example, the mobile robot 262 may pick up and carry boxes between different locations in the system 100. The system 100 may also include the automatic battery charging/swapping station 130C, with a number of battery storage locations 750A-n such as described in reference to FIGS. 7A-12E. For example, one battery storage location 750A may include a battery being charged, and a second battery storage location 750B may be available to accept a depleted battery. The system 100 also includes the battery swapping mechanism 710 located at the automatic battery charging/swapping station 130C to move batteries between individual mobile robots 262 outside the station 130C and the battery storage locations 750A-n, inside the station 130C.

Still referring to at least FIGS. 1, 7A-9D, and 13, the method may further involve the mobile robot 262 determining, via controller 262C, that battery 289 is depleted or has reached a predetermined charge state. The controller 262C communicates with the warehouse control 2500 to determine a route to an available automatic battery charging/swapping station 130C distributed throughout the system 100.

More specifically, after the mobile robot 262 has operated for some time with battery 289, the battery may be partially depleted. The mobile robot 262 navigates to the automatic battery charging/swapping station 130C to transfer the battery 289 to the automatic battery charging/swapping station 130C. The transferred battery is inserted into a free battery storage location 750A-n to be recharged and a fresh battery is transferred from the station 130C to the mobile robot 262.

In some aspects, upon docking with the automatic battery charging/swapping station 130C, the battery exchange process is commenced/triggered. Battery 289 is physically transferred by the battery swapping mechanism 710 to an available battery storage location 750A-n at the automatic battery charging/swapping station 130C.

Method 1400 may further involve the mobile robot 262 receiving a new battery from the automatic battery charging/swapping station 130C to continue operation within the environment. More specifically, after transferring the depleted battery to the automatic battery charging/swapping station 130C, the mobile robot 262 may then receive another new or recharged battery. Accordingly, the mobile robot 262 can continue operation within the fleet without having to wait for the battery that it used previously to be recharged.

As shown in FIG. 7A, an available battery may be stored at the automatic battery charging/swapping station 130C. In particular, another robot may have dropped off a depleted battery, which has now been recharged at the automatic battery charging/swapping station 130C (in other aspects a brand new battery may have been installed into the automatic battery charging/swapping station 130C). After receiving the new or recharged battery from the automatic battery charging/swapping station 130C, robot 262 may continue operation within the warehouse 100. In particular, robot 262 receives power from the new battery 289. Meanwhile, the battery previously used by robot 262 may be processed by the automatic battery charging/swapping station 130C in order to charge the battery for redeployment.

In accordance with one or more aspects of the disclosed embodiment an automatic battery swapping station for automatic battery swapping of a battery of an automated guided vehicle robot is provided. The automatic battery swapping station including an enclosure, with a configuration that is substantially closed, enclosing the automatic battery swapping station, with a narrowed opening, forming access from inside the housing enclosure to the battery of the automated guided vehicle robot docked outside the automatic battery swapping station, so that the enclosure provides a predetermined fire resistant criteria to the automatic battery swapping station, a robotic battery handling mechanism disposed inside the enclosure, the robotic battery handling mechanism having a drive section, providing the robotic battery handling mechanism at least one degree of freedom, and an end effector configured to handle the battery so that the battery is moved by the robotic battery handling mechanism, relative to the automatic battery swapping station, in the at least one degree of freedom, a battery storage with an array of battery storage locations distributed inside the enclosure, and wherein the robotic battery handling mechanism is arranged to move, via the at least one degree of freedom, between at least one of the battery storage locations and outside the automatic battery swapping station so as to swap the battery of the automated guided vehicle robot outside the automatic battery swapping station with a stored battery in the at least one of the battery storage locations through the narrowed opening.

In accordance with one or more aspects of the disclosed embodiment the enclosure is a unit shell.

In accordance with one or more aspects of the disclosed embodiment the robotic battery handling mechanism has a mounting frame and transfer chassis dependent from the mounting frame, the drive section being connected to the mounting frame and operably connected to the transfer chassis, wherein the mounting frame is disposed inside the enclosure.

In accordance with one or more aspects of the disclosed embodiment the robotic battery handling mechanism is disposed inside the enclosure and dependent from a wall of the enclosure.

In accordance with one or more aspects of the disclosed embodiment the mounting frame is juxtaposed proximate the array of battery storage locations, so that the robotic battery handling mechanism positioned by the mounting frame is proximate the array of battery storage locations.

In accordance with one or more aspects of the disclosed embodiment the drive section is a 3-drive axis drive section defining three degrees of freedom of the robotic battery handling mechanism.

In accordance with one or more aspects of the disclosed embodiment the narrowed opening is located at a bottom of the enclosure adjacent a drive surface of the automated guided vehicle robot outside the station.

In accordance with one or more aspects of the disclosed embodiment an automatic battery swapping station for automatic battery swapping of a battery of an automated guided vehicle robot is provided. The automatic battery swapping station including an automatic battery swapping station, and the automated guided vehicle robot having a battery interface that mounts the battery to the robot and cooperates automatically with a portion of the swapping station, wherein the swapping station has, an enclosure, with a configuration that is substantially closed, enclosing the automatic battery swapping station, with a narrowed opening, forming access from inside the enclosure to the battery of the automated guided vehicle robot outside the automatic battery swapping station, a robotic battery handling mechanism disposed inside the enclosure, the robotic battery handling mechanism having a drive section, providing the robotic battery handling mechanism at least one degree of freedom, and an end effector configured to handle the battery so that the battery is moved by the robotic battery handling mechanism, relative to the automatic battery swapping station, in the at least one degree of freedom, a battery storage with an array of battery storage locations distributed inside the enclosure, and wherein the robotic battery handling mechanism is arranged to move, via the at least one degree of freedom, between at least one of the battery storage locations and outside the automatic battery swapping station with a stored battery in the at least one of the battery storage locations, wherein the battery interface of the automated guided vehicle robot is configured so that automatic capture and release of the battery to and from the automated guided vehicle robot is effected via automatic engagement between the battery interface and the end effector extended outside the housing closure through the narrowed opening.

In accordance with one or more aspects of the disclosed embodiment the enclosure, with the narrow opening, is disposed so as to provide a predetermined fire resistant criteria to the station.

In accordance with one or more aspects of the disclosed embodiment the battery interface, of the automated guided vehicle robot, and end effector have a cooperating ramp and cam surfaces, disposed respectively on the battery interface and automated guided vehicle robot, that on engagement with each other, through the narrowed opening, effect the automatic capture and release of the battery to and from the automated guided vehicle robot.

In accordance with one or more aspects of the disclosed embodiment the battery interface, of the automated guided vehicle robot, and end effector have a cooperating ramp and cam surfaces, disposed respectively on the battery interface and automated guided vehicle robot, that on engagement with each other effect the automatic capture and release of the battery to and from the automated guided vehicle robot in substantially one step.

In accordance with one or more aspects of the disclosed embodiment the battery storage has a battery storage interface that holds the battery, loaded in the enclosure by the end effector through the narrowed opening and moved inside the enclosure to at least one of the battery storage locations, and the battery storage interface is configured so that automatic capture and release of the battery to and from the at least one battery storage location is effected via automatic engagement, in the enclosure, between the battery storage interface and the end effector.

In accordance with one or more aspects of the disclosed embodiment a method for automatic battery swapping of a battery of an automated guided vehicle robot with an automatic battery swapping station, the method including providing an enclosure, with a configuration that is substantially closed, enclosing the automatic battery swapping station, with a narrowed opening, forming access from inside the enclosure to the battery of the automated guided vehicle bot outside the automatic battery swapping station, the enclosure meeting a predetermined fire resistant criteria for the automatic battery swapping station, providing a robotic battery handling mechanism disposed inside the enclosure, the robotic battery handling mechanism having a drive section, providing the robotic battery handling mechanism at least one degree of freedom, and an end effector for handling the battery so that the battery is moved by the robotic battery handling mechanism, relative to the automatic battery swapping station, in the at least one degree of freedom, effecting swapping of the battery of the automated guided vehicle robot outside the automatic battery swapping station with a stored battery from a battery storage, with an array of battery storage locations distributed inside the housing closure, the robotic battery handling mechanism being arranged to move, via the at least one degree of freedom, between at least one of the battery storage locations and outside the automatic battery swapping station so as to swap the battery through the narrowed opening.

In accordance with one or more aspects of the disclosed embodiment the enclosure is a unit shell.

In accordance with one or more aspects of the disclosed embodiment the robotic battery handling mechanism has a mounting frame and transfer chassis dependent from the mounting frame, the drive section being connected to the mounting frame and operably connected to the transfer chassis, wherein the mounting frame is disposed inside the housing closure.

In accordance with one or more aspects of the disclosed embodiment the robotic battery handling mechanism is disposed inside the enclosure and dependent from a wall of the enclosure.

In accordance with one or more aspects of the disclosed embodiment the mounting frame is juxtaposed proximate the array of battery storage locations, so that the robotic battery handling mechanism positioned by the mounting frame is proximate the array of battery storage locations.

In accordance with one or more aspects of the disclosed embodiment the drive section is a 3-axis drive section defining three degrees of freedom of the robotic battery handling mechanism.

In accordance with one or more aspects of the disclosed embodiment the narrowed opening is located at a bottom of the enclosure adjacent a drive surface of the automated guided vehicle robot outside the station.

In accordance with one or more aspects of the disclosed embodiment a method for automatic battery swapping of a battery of an automated guided vehicle robot with an automatic battery swapping station, the method including providing an automatic battery swapping station having an enclosure, with a configuration that is substantially closed, enclosing the automatic battery swapping station, with a narrowed opening, forming access from inside the enclosure to the battery of the automated guided vehicle robot outside the automatic battery swapping station, a robotic battery handling mechanism disposed inside the enclosure, the robotic battery handling mechanism having a drive section, providing the robotic battery handling mechanism at least one degree of freedom, and an end effector for handling the battery so that the battery is moved by the robotic battery handling mechanism, relative to the automatic battery swapping station, in the at least one degree of freedom, and a battery storage with an array of battery storage locations distributed inside the enclosure, wherein the robotic battery handling mechanism is arranged to move, via the at least one degree of freedom, between at least one of the battery storage locations and outside the automatic battery swapping station with a stored battery in the at least one of the battery storage locations, providing the automated guided vehicle robot having a battery interface that mounts the battery to the robot and cooperates automatically with a portion of the swapping station, and swapping of the battery via automatic engagement between the battery interface of the automated guided vehicle robot, configured for automatic capturing and release of the battery to and from the automated guided vehicle robot, and the end effector extended outside the enclosure through the narrowed opening.

In accordance with one or more aspects of the disclosed embodiment the enclosure, with the narrow opening, is disposed so as to meet a predetermined fire resistant criteria.

In accordance with one or more aspects of the disclosed embodiment the battery interface, of the automated guided vehicle robot, and end effector have cooperating ramp and cam surfaces, disposed respectively on the battery interface and automated guided vehicle robot, effecting automatic capture and release of the battery to and from the automated guided vehicle robot on engagement with each other through the narrowed opening.

In accordance with one or more aspects of the disclosed embodiment the battery interface, of the automated guided vehicle robot, and end effector have cooperating ramp and cam surfaces, disposed respectively on the battery interface and automated guided vehicle robot, effecting automatic capture and release of the battery to and from the automated guided vehicle robot on engagement with each other, in substantially one step.

In accordance with one or more aspects of the disclosed embodiment the battery storage has a battery storage interface that holds the battery, loaded in the enclosure by the end effector through the narrowed opening and moved inside the enclosure to at least one of the battery storage locations, and the battery storage interface is configured so that automatic capture and release of the battery to and from the at least one battery storage location is effected via automatic engagement, in the enclosure, between the battery storage interface and the end effector.

In accordance with one or more aspects of the disclosed embodiment an automatic battery swapping station for automatic battery swapping of a battery of an automated guided vehicle robot is provided. The automatic battery swapping station including an enclosure, with a configuration that is substantially closed, enclosing the automatic battery swapping station, with a narrowed opening, forming access from inside the housing enclosure to the battery of the automated guided vehicle robot docked outside the automatic battery swapping station, so that the enclosure provides a predetermined fire resistant criteria to the automatic battery swapping station, a robotic battery handling mechanism disposed inside the enclosure, the robotic battery handling mechanism having a drive section, providing the robotic battery handling mechanism at least one degree of freedom, and an end effector configured to handle the battery so that the battery is moved by the robotic battery handling mechanism, relative to the automatic battery swapping station, in the at least one degree of freedom, an array of battery charging locations distributed inside the enclosure, and wherein the robotic battery handling mechanism is arranged to move, via the at least one degree of freedom, between at least one of the battery charging locations and outside the automatic battery swapping station so as to swap the battery of the automated guided vehicle robot outside the automatic battery swapping station with a stored battery in the at least one of the battery charging locations through the narrowed opening.

In accordance with one or more aspects of the disclosed embodiment an automatic battery swapping station for automatic battery swapping of a battery of an automated guided vehicle robot is provided. The automatic battery swapping station including an enclosure, with a configuration that is substantially closed, enclosing the automatic battery swapping station, with a narrowed opening, forming access from inside the housing enclosure to the battery of the automated guided vehicle robot docked outside the automatic battery swapping station, so that the enclosure provides a predetermined fire resistant criteria to the automatic battery swapping station, a robotic battery handling mechanism disposed inside the enclosure, the robotic battery handling mechanism having a drive section, providing the robotic battery handling mechanism at least one degree of freedom, and an end effector configured to handle the battery so that the battery is moved by the robotic battery handling mechanism, relative to the automatic battery swapping station, in the at least one degree of freedom, an array of battery docking locations distributed inside the enclosure, and wherein the robotic battery handling mechanism is arranged to move, via the at least one degree of freedom, between at least one of the battery docking locations and outside the automatic battery swapping station so as to swap the battery of the automated guided vehicle robot outside the automatic battery swapping station with a stored battery in the at least one of the battery docking locations through the narrowed opening.

It should be understood that the foregoing description is only illustrative of the present disclosure. Various alternatives and modifications can be devised by those skilled in the art without departing from the present disclosure. Accordingly, the present disclosure is intended to embrace all such alternatives, modifications and variances that fall within the scope of any claims appended hereto. Further, the mere fact that different features are recited in mutually different dependent or independent claims does not indicate that a combination of these features cannot be advantageously used, such a combination remaining within the scope of the present disclosure.

What is claimed is:

1. An automatic battery swapping station for automatic battery swapping of a battery of an automated guided vehicle robot, the automatic battery swapping station comprising:
a housing closure, with a configuration that is substantially closed, enclosing the automatic battery swapping station, with a narrowed opening, forming access from inside the housing closure to the battery of the automated guided vehicle robot outside the automatic battery swapping station, so that the housing closure provides a predetermined fire retardant rating to the automatic battery swapping station;
a robotic transfer mechanism disposed inside the housing closure, the robotic transfer mechanism having a drive section, providing the robotic transfer mechanism at least one degree of freedom, and an end effector configured to grip the battery so that the battery is moved by the robotic transfer mechanism, relative to the automatic battery swapping station, in the at least one degree of freedom;
a battery storage with an array of battery storage locations distributed inside the housing closure, and wherein the robotic transfer mechanism is arranged to move, via the at least one degree of freedom, between at least one of the battery storage locations and outside the automatic battery swapping station so as to swap the battery of the automated guided vehicle robot outside the automatic battery swapping station with a stored battery in the at least one of the battery storage locations through the narrowed opening.

2. The automatic battery swapping station of claim 1, wherein the housing closure is a unit shell.

3. The automatic battery swapping station of claim 1, wherein the robotic transfer mechanism has a mounting frame and transfer chassis dependent from the mounting frame, the drive section being connected to the mounting frame and operably connected to the transfer chassis, wherein the mounting frame is disposed inside the housing closure.

4. The automatic battery swapping station of claim 3, wherein the mounting frame is juxtaposed proximate the array of battery storage locations, so that the robotic transfer mechanism positioned by the mounting frame is proximate the array of battery storage locations.

5. The automatic battery swapping station of claim 1, wherein the drive section is a 3-drive axis drive section defining three degrees of freedom of the robotic transfer mechanism.

6. The automatic battery swapping station of claim 1, wherein the narrowed opening is located at a bottom of the housing closure adjacent a drive surface of the automated guided vehicle robot outside the station.

7. An automatic battery swap system for automatic battery swapping of a battery of an automated guided vehicle robot, the system comprising:
an automatic battery swapping station; and
the automated guided vehicle robot having a battery interface that mounts the battery to the robot and cooperates automatically with a portion of the swapping station;
wherein the swapping station has;
a housing closure, with a configuration that is substantially closed, enclosing the automatic battery swapping station, with a narrowed opening, forming access from inside the housing closure to the battery of the automated guided vehicle robot outside the automatic battery swapping station;
a robotic transfer mechanism disposed inside the housing closure, the robotic transfer mechanism having a drive section, providing the robotic transfer mechanism at least one degree of freedom, and an end effector configured to grip the battery so that the battery is moved by the robotic transfer mechanism, relative to the automatic battery swapping station, in the at least one degree of freedom;
a battery storage with an array of battery storage locations distributed inside the housing closure, and wherein the robotic transfer mechanism is arranged to move, via the at least one degree of freedom, between at least one of the battery storage locations and outside the automatic battery swapping station with a stored battery in the at least one of the battery storage locations;
wherein the battery interface of the automated guided vehicle robot is configured so that automatic capture and release of the battery to and from the automated guided vehicle robot is effected via automatic engagement between the battery interface and the end effector extended outside the housing closure through the narrowed opening.

8. The automatic battery swapping station of claim 7, wherein the housing closure, with the narrow opening, is disposed so as to provide a predetermined fire retardant rating to the station.

9. The automatic battery swapping station of claim 7, wherein the battery interface, of the automated guided vehicle robot, and end effector have a cooperating ramp and cam surfaces, disposed respectively on the battery interface and automated guided vehicle robot, that on engagement with each other, through the narrowed opening, effect the automatic capture and release of the battery to and from the automated guided vehicle robot.

10. The automatic battery swapping station of claim 7, wherein the battery interface, of the automated guided vehicle robot, and end effector have a cooperating ramp and cam surfaces, disposed respectively on the battery interface and automated guided vehicle robot, that on engagement with each other effect the automatic capture and release of the battery to and from the automated guided vehicle robot in substantially one step.

11. The automatic battery swapping station of claim 7, wherein the battery storage has a battery storage interface that holds the battery, loaded in the housing closure by the end effector through the narrowed opening and moved inside the housing closure to at least one of the battery storage locations, and the battery storage interface is configured so that automatic capture and release of the battery to and from the at least one battery storage location is effected via automatic engagement, in the housing closure, between the battery storage interface and the end effector.

12. A method for automatic battery swapping of a battery of an automated guided vehicle robot with an automatic battery swapping station, the method comprising:
providing a housing closure, with a configuration that is substantially closed, enclosing the automatic battery swapping station, with a narrowed opening, forming access from inside the housing closure to the battery of the automated guided vehicle robot outside the automatic battery swapping station, the housing closure providing a predetermined fire retardant rating to the automatic battery swapping station;
providing a robotic transfer mechanism disposed inside the housing closure, the robotic transfer mechanism having a drive section, providing the robotic transfer mechanism at least one degree of freedom, and an end effector for gripping the battery so that the battery is moved by the robotic transfer mechanism, relative to the automatic battery swapping station, in the at least one degree of freedom;
effecting swapping of the battery of the automated guided vehicle robot outside the automatic battery swapping station with a stored battery from a battery storage, with an array of battery storage locations distributed inside the housing closure, the robotic transfer mechanism being arranged to move, via the at least one degree of freedom, between at least one of the battery storage locations and outside the automatic battery swapping station so as to swap the battery through the narrowed opening.

13. The method of claim 12, wherein the housing closure is a unit shell.

14. The method of claim 12, wherein the robotic transfer mechanism has a mounting frame and transfer chassis dependent from the mounting frame, the drive section being connected to the mounting frame and operably connected to the transfer chassis, wherein the mounting frame is disposed inside the housing closure.

15. The method of claim 14, wherein the mounting frame is juxtaposed proximate the array of battery storage locations, so that the robotic transfer mechanism positioned by the mounting frame is proximate the array of battery storage locations.

16. The method of claim 12, wherein the drive section is a 3-drive axis drive section defining three degrees of freedom of the robotic transfer mechanism.

17. The method of claim 12, wherein the narrowed opening is located at a bottom of the housing closure adjacent a drive surface of the automated guided vehicle robot outside the station.

18. A method for automatic battery swapping of a battery of an automated guided vehicle robot with an automatic battery swapping station, the method comprising:
providing an automatic battery swapping station having:
a housing closure, with a configuration that is substantially closed, enclosing the automatic battery swapping station, with a narrowed opening, forming access from inside the housing closure to the battery of the automated guided vehicle robot outside the automatic battery swapping station,
a robotic transfer mechanism disposed inside the housing closure, the robotic transfer mechanism having a drive section, providing the robotic transfer mechanism at least one degree of freedom, and an end effector for gripping the battery so that the battery is moved by the robotic transfer mechanism, relative to the automatic battery swapping station, in the at least one degree of freedom, and
a battery storage with an array of battery storage locations distributed inside the housing closure;
providing the automated guided vehicle robot having a battery interface that mounts the battery to the robot and cooperates automatically with a portion of the swapping station, wherein the robotic transfer mechanism is arranged to move, via the at least one degree of freedom, between at least one of the battery storage locations and outside the automatic battery swapping station with a stored battery in the at least one of the battery storage locations;
effecting swapping of the battery via automatic engagement between the battery interface of the automated guided vehicle robot, configured for automatic capturing and release of the battery to and from the automated guided vehicle robot, and the end effector extended outside the housing closure through the narrowed opening.

19. The method of claim 18, wherein the housing closure, with the narrow opening, is disposed for providing a predetermined fire retardant rating to the station.

20. The method of claim 18, wherein the battery interface, of the automated guided vehicle robot, and end effector have cooperating ramp and cam surfaces, disposed respectively on the battery interface and automated guided vehicle robot, effecting automatic capture and release of the battery to and from the automated guided vehicle robot on engagement with each other through the narrowed opening.

21. The method of claim 18, wherein the battery interface, of the automated guided vehicle robot, and end effector have cooperating ramp and cam surfaces, disposed respectively on the battery interface and automated guided vehicle robot, effecting automatic capture and release of the battery to and from the automated guided vehicle robot on engagement with each other, in substantially one step.

22. The method of claim 18, wherein the battery storage has a battery storage interface that holds the battery, loaded in the housing closure by the end effector through the narrowed opening and moved inside the housing closure to at least one of the battery storage locations, and the battery storage interface is configured so that automatic capture and release of the battery to and from the at least one battery storage location is effected via automatic engagement, in the housing closure, between the battery storage interface and the end effector.
